(19) United States
(12) Patent Application Publication
(10) Pub. No.: US 2022/0303020 A1
(43) Pub. Date: Sep. 22, 2022

(54) CENTRAL UNIT, REMOTE UNIT, SMALL CELL SYSTEM, AND COMMUNICATION METHOD

(71) Applicant: HUAWEI TECHNOLOGIES CO., LTD., Shenzhen (CN)

(72) Inventors: Xu LI, Shenzhen (CN); Tianxiang WANG, Shenzhen (CN); Rongdao YU, Shenzhen (CN)

(21) Appl. No.: 17/832,825

(22) Filed: Jun. 6, 2022

Related U.S. Application Data
(63) Continuation of application No. PCT/CN2020/127966, filed on Nov. 11, 2020.

(30) Foreign Application Priority Data
Dec. 6, 2019 (CN) 201911243332.1

(51) Int. Cl. H04B 10/61; H04B 10/2575; H04B 10/50; H04B 10/572; H04J 14/02

(52) U.S. Cl. CPC H04B 10/614; H04B 10/25759; H04B 10/506; H04B 10/572; H04J 14/0202; H04B 10/503

(57) ABSTRACT

Embodiments of this application provide a central unit, a remote unit, a small cell system, and a communication method. A digital-to-analog conversion (DAC) module and an analog-to-digital conversion (ADC) module are disposed in the central unit, so that the central unit transmits an analog optical signal to the remote unit. When the central unit transmits the analog optical signal to a plurality of remote units, because a processing delay of an analog component in analog transmission is usually at a nanosecond level, and a total delay formed by a path transmission delay and the processing delay fluctuates slightly or even is fixed, synchronization of the plurality of remote units can be easily implemented in the central unit through calibration. Therefore, it is possible to easily implement a distributed MIMO function.

### CROSS-REFERENCE TO RELATED APPLICATIONS

This application is a continuation of International Application No. PCT/CN2020/127966, filed on Nov. 11, 2020, which claims priority to Chinese Patent Application No. 201911243332.1 filed on Dec. 6, 2019. The disclosures of the aforementioned applications are hereby incorporated by reference in their entireties.

### TECHNICAL FIELD

This application relates to communication technologies, and in particular, to a central unit, a remote unit, a small cell system, and a communication method.

### BACKGROUND

In a multiple-input multiple-output (MIMO) technology, a plurality of transmit antennas and a plurality of receive antennas are used at a transmit end and a receive end respectively, so that a signal is transmitted and received through the plurality of antennas at the transmit end and the receive end, thereby improving communication quality. MIMO is considered as an important technology in the communication field because the MIMO technology can use space resources and effectively increase system channel capacity without increasing spectrum resources and antenna transmit power.

In a conventional technology, to meet wireless coverage requirements of areas such as a campus, an airport, a parking lot, and an office, a small cell product is gradually developed. For example, mainstream small cell products in the industry include a Lampsite system of HUAWEI, a Qcell system of ZTE, and a Dot system of Ericsson.

However, in a small cell system in the conventional technology, it is difficult to implement a distributed MIMO function. This seriously restricts development of a small cell technology.

### SUMMARY

Embodiments of this application provide a central unit, a remote unit, a small cell system, and a communication method, to construct a small cell that can easily implement a distributed MIMO function, and improve communication quality of the small cell system.

According to a first aspect, embodiments of this application provide a central unit, including a digital-to-analog conversion (DAC) module, an analog-to-digital conversion (ADC) module, a first electrical-to-optical conversion module, and a first optical-to-electrical conversion module.

The DAC module is configured to convert a baseband signal into a first analog electrical signal, where the first analog electrical signal is a zero frequency signal, an intermediate frequency signal, or a radio frequency signal. The first electrical-to-optical conversion module is configured to convert the first analog electrical signal into a first optical signal, and output the first optical signal to a remote unit. The first optical-to-electrical conversion module is configured to convert a second optical signal received from the remote unit into a second analog electrical signal, where the second analog electrical signal is a zero frequency signal, an intermediate frequency signal, or a radio frequency signal. The ADC module is configured to convert the second analog electrical signal into a digital signal. In embodiments of this application, the digital-to-analog conversion DAC module and the analog-to-digital conversion ADC module are disposed in the central unit, so that the central unit transmits an analog optical signal to the remote unit. When the central unit transmits the analog optical signal to a plurality of remote units, because a processing delay of an analog component in analog transmission is usually at a nanosecond level, and a total delay formed by a path transmission delay and the processing delay fluctuates slightly or even is fixed, synchronization of the plurality of remote units can be easily implemented in the central unit through calibration. Therefore, it is possible to easily implement a distributed MIMO function.

In a possible design, the central unit further includes an intermediate and/or radio frequency module, and the intermediate and/or radio frequency module is configured to convert the first analog electrical signal into an electrical signal at a first frequency. The first electrical-to-optical conversion module is configured to convert the electrical signal at the first frequency into the first optical signal, and output the first optical signal to the remote unit. In addition or alternatively, the intermediate and/or radio frequency module is configured to convert an electrical signal at a second frequency into the second analog electrical signal. The ADC module is configured to convert the second analog electrical signal into the digital signal. When a value of the first frequency is high, a harmonic spacing of the electrical signal is large and easy to filter out, and signal quality is good.

In a possible design, the first electrical-to-optical conversion module is configured to convert M first analog electrical signals into M first optical signals, and output the M first optical signals to the remote unit, where M is an integer greater than or equal to 1. The first optical-to-electrical conversion module is configured to convert N second optical signals received from the remote unit into N second analog electrical signals, where N is an integer greater than or equal to 1. When the central unit transmits the first optical signal to the plurality of remote units, because the processing delay of the analog component in analog transmission is usually at a nanosecond level, and the total delay formed by the path transmission delay and the processing delay fluctuates slightly or even is fixed, the synchronization of the plurality of remote units can be easily implemented in the central unit through calibration. Therefore, it is possible to easily implement the distributed MIMO function.

In a possible design, the central unit further includes at least one of the following: a first wavelength division multiplexer MUX or a first demultiplexer DEMUX. The first MUX is configured to combine the M first optical signals and output the signal to the remote unit. The first DEMUX is configured to split the N second optical signals, and output the split second optical signals to the first optical-to-electrical conversion module. Because there are the first MUX and the first DEMUX in the central unit, when the central unit transmits a signal to a converging unit, a transmit link or a receive link may be implemented by using one optical fiber, and a communication link between the central unit and the converging unit is simple.

In a possible design, the central unit is further configured to input an optical power control signal to the first electrical-to-optical conversion module. The first electrical-to-optical conversion module is further configured to output optical power related to the optical power control signal, where the optical power is used to control an amplification multiple of an amplifier in the remote unit.

In a possible design, the first electrical-to-optical conversion module includes a directly modulated laser source, and the optical power control signal is a direct current bias current. The central unit is further configured to input the direct current bias current to the directly modulated laser source. In embodiments of this application, a simple remote unit is constructed, and the remote unit may not include an ADC module, a DAC module, and a digital processing module. Therefore, the remote unit may not be able to control an amplification multiple of an amplifier by using numerical control of the remote unit. Therefore, in actual application, if the amplification multiple of the amplifier needs to be adjusted, the amplification multiple may be controlled through the central unit.

In a possible design, the first electrical-to-optical conversion module includes an indirect modulator and a laser source. The optical power control signal is a direct current bias current, and the central unit is further configured to input the direct current bias current to the laser source. Alternatively, the optical power control signal is a bias voltage, and the central unit is further configured to input the bias voltage to the indirect modulator.

According to a second aspect, embodiments of this application provide a remote unit, including a second optical-to-electrical conversion module, a second electrical-to-optical conversion module, and an amplifier.

The second optical-to-electrical conversion module is configured to convert a third optical signal received from a central unit into a third analog electrical signal. The third optical signal is an optical signal obtained by converting an analog electrical signal. The third analog electrical signal is a zero frequency signal, an intermediate frequency signal, or a radio frequency signal. The amplifier is configured to amplify the third analog electrical signal. The second electrical-to-optical conversion module is configured to convert a fourth analog electrical signal into a fourth optical signal, and output the fourth optical signal to the central unit. The fourth analog electrical signal is a zero frequency signal, an intermediate frequency signal, or a radio frequency signal. In embodiments of this application, the remote unit has a simple structure, and may include fewer modules. Therefore, the remote unit may be conveniently disposed in a small cell system.

In a possible design, the second optical-to-electrical conversion module is further configured to convert optical power related to the optical power control signal into a direct current. The amplifier is further configured to amplify the third analog electrical signal by using an amplification multiple related to the direct current.

In a possible design, the remote unit further includes an up-conversion mixer module and a down-conversion mixer module. The up-conversion mixer module is configured to convert the third analog electrical signal into an electrical signal at a third frequency. The amplifier is configured to amplify the electrical signal at the third frequency. The down-conversion mixer module is configured to convert the fourth analog electrical signal into an electrical signal at a fourth frequency. The second electrical-to-optical conversion module is configured to convert the electrical signal at the fourth frequency into the fourth optical signal, and output the fourth optical signal to the central unit.

According to a third aspect, embodiments of this application provide a small cell system, including the central unit according to the first aspect or any possible design of the first aspect, and the remote unit according to the second aspect or any possible design of the second aspect.

In a possible design, the small cell system further includes a converging unit. The central unit is connected to one or more remote units through the converging unit.

In a possible design, the converging unit includes a second wavelength division multiplexer MUX and a second demultiplexer DEMUX. The second DEMUX is configured to split an optical signal combined by a first MUX of the central unit, and output the split optical signals to one or more remote units. The second MUX is configured to combine a plurality of optical signals received from the one or more remote units, and transmit the combined optical signal to a first DEMUX of the central unit.

In a possible design, the small cell system further includes an optical fiber transmit link. The central unit and the one or more remote units are connected through an optical fiber transmit link.

In a possible design, the optical fiber transmit link includes one or more third wavelength division multiplexers MUXs and one or more third demultiplexers DEMUXs. Any third DEMUX is configured to split, from an optical signal combined by a first MUX of the central unit, a target optical signal related to a remote unit connected to the any third DEMUX, and output the target optical signal to a remote unit connected to the any third DEMUX. Any third MUX is configured to combine optical signals received from a remote unit connected to any third MUX, and output the combined optical signal to a first DEMUX of the central unit.

According to a fourth aspect, embodiments of this application provide a communication method, used in a central unit, including: converting a baseband signal into a first analog electrical signal, where the first analog electrical signal is a zero frequency signal, an intermediate frequency signal, or a radio frequency signal; converting the first analog electrical signal into a first optical signal and outputting the first optical signal to a remote unit; converting a second optical signal received from the remote unit into a second analog electrical signal, where the second analog electrical signal is a zero frequency signal, an intermediate frequency signal, or a radio frequency signal; and converting the second analog electrical signal into a digital signal.

In a possible design, the method further includes: converting the first analog electrical signal into an electrical signal at a first frequency, where the converting the first analog electrical signal into a first optical signal and outputting the first optical signal to a remote unit includes: converting the electrical signal at the first frequency into the first optical signal and outputting the first optical signal to the remote unit; and converting the second analog electrical signal into an electrical signal at a second frequency, where the converting the second analog electrical signal into a digital signal includes: converting an analog electrical signal at the second frequency into the digital signal.

In a possible design, the converting the first analog electrical signal into a first optical signal and outputting the first optical signal to a remote unit includes: converting M first analog electrical signals into M first optical signals and outputting the M first optical signals to the remote unit, where M is an integer greater than or equal to 1; and the converting a second optical signal received from the remote unit into a second analog electrical signal includes: converting N second optical signals received from the remote unit into N second analog electrical signals, where N is an integer greater than or equal to 1.

In a possible design, the converting M first analog electrical signals into M first optical signals and outputting the M first optical signals to the remote unit includes: combining the M first optical signals and outputting the first optical signal to the remote unit; and the converting N second optical signals received from the remote unit into N second analog electrical signals includes: splitting the N second optical signals, and converting the split second optical signals into the N second analog electrical signals.

In a possible design, the method further includes: inputting an optical power control signal to a first electrical-to-optical conversion module; and outputting optical power related to the optical power control signal, where the optical power is used to control an amplification multiple of an amplifier in the remote unit.

In a possible design, the first electrical-to-optical conversion module includes a directly modulated laser source, and the optical power control signal is a direct current bias current. The inputting an optical power control signal to a first electrical-to-optical conversion module includes: inputting the direct current bias current to the directly modulated laser source.

In a possible design, the first electrical-to-optical conversion module includes an indirect modulator and a laser source, the optical power control signal is a direct current bias current, and the inputting an optical power control signal to a first electrical-to-optical conversion module includes: inputting the direct current bias current to the laser source; or the optical power control signal is a bias voltage, and the inputting an optical power control signal to a first electrical-to-optical conversion module includes: inputting the bias voltage to the indirect modulator.

According to a fifth aspect, embodiments of this application provide a communication method, used in a remote unit, including: converting a third optical signal received from a central unit into a third analog electrical signal, where the third optical signal is an optical signal obtained by converting an analog electrical signal, and the third analog electrical signal is a zero frequency signal, an intermediate frequency signal, or a radio frequency signal; amplifying the third analog electrical signal; and converting a fourth analog electrical signal into a fourth optical signal and outputting the fourth optical signal to a central unit, where the fourth analog electrical signal is a zero frequency signal, an intermediate frequency signal, or a radio frequency signal.

In a possible design, the method further includes: converting optical power related to an optical power control signal into a direct current. The amplifying the third analog electrical signal includes: amplifying the third analog electrical signal by using an amplification multiple related to the direct current.

In a possible design, the method further includes: converting the third analog electrical signal into an electrical signal at a third frequency, and the amplifying a third analog electrical signal includes: amplifying the electrical signal at the third frequency; and converting the fourth analog electrical signal into an electrical signal at a fourth frequency, and, the converting a fourth analog electrical signal into a fourth optical signal and outputting the fourth optical signal to a central unit includes: converting the electrical signal at the fourth frequency into the fourth optical signal and outputting the fourth optical signal to the central unit.

According to a sixth aspect, embodiments of this application provide a communication method, used in a small cell system, including: A central unit converts a baseband signal into a first analog electrical signal, where the first analog electrical signal is a zero frequency signal, an intermediate frequency signal, or a radio frequency signal; the central unit converts the first analog electrical signal into a first optical signal and outputs the first optical signal to a remote unit; the remote unit converts the first optical signal received from the central unit into a third analog electrical signal, where the third analog electrical signal is a zero frequency signal, an intermediate frequency signal, or a radio frequency signal; the remote unit amplifies the third analog electrical signal, converts a fourth analog electrical signal into a fourth optical signal, and outputs the fourth optical signal to the central unit, where the fourth analog electrical signal is a zero frequency signal, an intermediate frequency signal, or a radio frequency signal; the central unit converts the fourth optical signal received from the remote unit into a second analog electrical signal, where the second analog electrical signal is a zero frequency signal, an intermediate frequency signal, or a radio frequency signal; and the central unit converts the second analog electrical signal into a digital signal.

According to a seventh aspect, embodiments of this application provide a central unit, including a digital-to-analog conversion DAC circuit, an analog-to-digital conversion ADC circuit, a first electrical-to-optical conversion circuit, and a first optical-to-electrical conversion circuit.

The DAC circuit is configured to convert a baseband signal into a first analog electrical signal, where the first analog electrical signal is a zero frequency signal, an intermediate frequency signal, or a radio frequency signal. The first electrical-to-optical conversion circuit is configured to convert the first analog electrical signal into a first optical signal, and output the first optical signal to a remote unit. The first optical-to-electrical conversion circuit is configured to convert a second optical signal received from the remote unit into a second analog electrical signal, where the second analog electrical signal is a zero frequency signal, an intermediate frequency signal, or a radio frequency signal. The ADC circuit is configured to convert the second analog electrical signal into a digital signal. In embodiments of this application, the digital-to-analog conversion DAC circuit and the analog-to-digital conversion ADC circuit are disposed in the central unit, so that the central unit transmits an analog optical signal to the remote unit. When the central unit transmits the analog optical signal to a plurality of remote units, because a processing delay of an analog component in analog transmission is usually at a nanosecond level, and a total delay formed by a path transmission delay and the processing delay fluctuates slightly or even is fixed, synchronization of the plurality of remote units can be easily implemented in the central unit through calibration. Therefore, it is possible to easily implement a distributed MIMO function.

In a possible design, the central unit further includes an intermediate and/or radio frequency circuit, and the intermediate and/or radio frequency circuit is configured to convert the first analog electrical signal into an electrical signal at a first frequency. The first electrical-to-optical conversion circuit is configured to convert the electrical signal at the first frequency into the first optical signal, and output the first optical signal to the remote unit. In addition or alternatively, the intermediate radio frequency circuit is configured to convert the second analog electrical signal into an electrical signal at a second frequency. The ADC circuit is configured to convert an analog electrical signal at the second frequency into the digital signal. When a value of the first frequency is high, a harmonic spacing of the electrical signal is large and easy to filter out, and signal quality is good.

In a possible design, the first electrical-to-optical conversion circuit is configured to convert M first analog electrical signals into M first optical signals, and output the M first optical signals to the remote unit, where M is an integer greater than or equal to 1. The first optical-to-electrical conversion circuit is configured to convert N second optical signals received from the remote unit into N second analog electrical signals, where N is an integer greater than or equal to 1. When the central unit transmits the first optical signal to the plurality of remote units, because the processing delay of the analog component in analog transmission is usually at a nanosecond level, and the total delay formed by the path transmission delay and the processing delay fluctuates slightly or even is fixed, the synchronization of the plurality of remote units can be easily implemented in the central unit through calibration. Therefore, it is possible to easily implement the distributed MIMO function.

In a possible design, the central unit further includes at least one of the following: a first wavelength division multiplexer MUX or a first demultiplexer DEMUX. The first MUX is configured to combine the M first optical signals and output the signal to the remote unit. The first DEMUX is configured to split the N second optical signals, and output the split second optical signal to the first optical-to-electrical conversion circuit. Because there are the first MUX and the first DEMUX in the central unit, when the central unit transmits a signal to a converging unit, a transmit link or a receive link may be implemented by using one optical fiber, and a communication link between the central unit and the converging unit is simple.

In a possible design, the central unit is further configured to input an optical power control signal to the first electrical-to-optical conversion circuit. The first electrical-to-optical conversion circuit is further configured to output optical power related to the optical power control signal, where the optical power is used to control an amplification multiple of an amplifier in the remote unit.

In a possible design, the first electrical-to-optical conversion circuit includes a directly modulated laser source, and the optical power control signal is a direct current bias current. The central unit is further configured to input the direct current bias current to the directly modulated laser source. In embodiments of this application, a simple remote unit is constructed, and the remote unit may not include an ADC circuit, a DAC circuit, and a digital processing circuit. Therefore, the remote unit may not be able to control an amplification multiple of an amplifier by using numerical control of the remote unit. Therefore, in actual application, if the amplification multiple of the amplifier needs to be adjusted, the amplification multiple may be controlled through the central unit.

In a possible design, the first electrical-to-optical conversion circuit includes an indirect modulator and a laser source. The optical power control signal is a direct current bias current, and the central unit is further configured to input the direct current bias current to the laser source. Alternatively, the optical power control signal is a bias voltage, and the central unit is further configured to input the bias voltage to the indirect modulator.

According to an eighth aspect, embodiments of this application provide a remote unit, including a second optical-to-electrical conversion circuit, a second electrical-to-optical conversion circuit, and an amplifier.

The second optical-to-electrical conversion circuit is configured to convert a third optical signal received from a central unit into a third analog electrical signal. The third optical signal is an optical signal obtained by converting an analog electrical signal. The third analog electrical signal is a zero frequency signal, an intermediate frequency signal, or a radio frequency signal. The amplifier is configured to amplify the third analog electrical signal. The second electrical-to-optical conversion circuit is configured to convert a fourth analog electrical signal into a fourth optical signal, and output the fourth optical signal to the central unit. The fourth analog electrical signal is a zero frequency signal, an intermediate frequency signal, or a radio frequency signal. In embodiments of this application, the remote unit has a simple structure, and may include fewer circuits. Therefore, the remote unit may be conveniently disposed in a small cell system.

In a possible design, the second optical-to-electrical conversion circuit is further configured to convert optical power related to the optical power control signal into a direct current. The amplifier is further configured to amplify the third analog electrical signal by using an amplification multiple related to the direct current.

In a possible design, the remote unit further includes an up-conversion mixer circuit and a down-conversion mixer circuit. The up-conversion mixer circuit is configured to convert the third analog electrical signal into an electrical signal at a third frequency. The amplifier is configured to amplify the electrical signal at the third frequency. The down-conversion mixer circuit is configured to convert the fourth analog electrical signal into an electrical signal at a fourth frequency. The second electrical-to-optical conversion circuit is configured to convert the electrical signal at the fourth frequency into the fourth optical signal, and output the fourth optical signal to the central unit.

According to a ninth aspect, embodiments of this application provide a small cell system, including the central unit according to the seventh aspect or any possible design of the seventh aspect, and the remote unit according to the eighth aspect or any possible design of the eighth aspect.

In a possible design, the small cell system further includes a converging unit. The central unit is connected to one or more remote units through the converging unit.

In a possible design, the converging unit includes a second wavelength division multiplexer MUX and a second demultiplexer DEMUX. The second DEMUX is configured to split an optical signal combined by a first MUX of the central unit, and output the split optical signals to one or more remote units. The second MUX is configured to combine a plurality of optical signals received from the one or more remote units, and transmit the combined optical signal to a first DEMUX of the central unit.

In a possible design, the small cell system further includes an optical fiber transmit link. The central unit and the one or more remote units are connected through an optical fiber transmit link.

In a possible design, the optical fiber transmit link includes one or more third wavelength division multiplexers MUXs and one or more third demultiplexers DEMUXs. Any third DEMUX is configured to split, from an optical signal combined by a first MUX of the central unit, a target optical signal related to a remote unit connected to the any third DEMUX, and output the target optical signal to a remote unit connected to the any third DEMUX. Any third MUX is configured to combine optical signals received from a remote unit connected to any third MUX, and output the combined optical signal to a first DEMUX of the central unit.

It should be understood that, the technical solutions of the second aspect to the ninth aspect of this application correspond to the technical solutions of the first aspect of this application, and beneficial effects obtained by each aspect and corresponding feasible implementations are similar and are not described in detail again.

### BRIEF DESCRIPTION OF DRAWINGS

FIG. 1 is a schematic diagram depicting a structure of an existing small cell system;

FIG. 2 is a schematic diagram depicting a structure of another existing small cell system;

FIG. 3 is a schematic diagram depicting a structure of a central unit according to an embodiment of this application;

FIG. 4 is a schematic diagram depicting a structure of a remote unit according to an embodiment of this application;

FIG. 5 is a schematic diagram depicting a structure of a small cell system according to an embodiment of this application;

FIG. 6 is a schematic diagram depicting a structure of an electrical-to-optical conversion module according to an embodiment of this application;

FIG. 7 is a schematic diagram depicting a structure of another electrical-to-optical conversion module according to an embodiment of this application:

FIG. 8 is a schematic diagram depicting a structure of still another electrical-to-optical conversion module according to an embodiment of this application;

FIG. 9A to FIG. 9E are schematic diagrams depicting a structure of a specific small cell system according to an embodiment of this application:

FIG. 10A to FIG. 10E are schematic diagrams depicting a structure of another specific small cell system according to an embodiment of this application:

FIG. 11A to FIG. 11D are schematic diagrams depicting a structure of still another specific small cell system according to an embodiment of this application:

FIG. 12A to FIG. 12D is a schematic diagram depicting a structure of yet another specific small cell system according to an embodiment of this application:

FIG. 13 is a schematic flowchart of a communication method according to an embodiment of this application;

FIG. 14 is a schematic flowchart of another communication method according to an embodiment of this application; and

FIG. 15 is a schematic flowchart of still another communication method according to an embodiment of this application.

### DESCRIPTION OF EMBODIMENTS

The solutions in embodiments of this application may be used in long term evolution (LTE), a fifth generation (5G) mobile communication system, or a future mobile communication system.

In description in embodiments of this application. “/” means “or” unless otherwise specified. For example, A/B may represent A or B. In this specification, “and/or” describes only an association relationship for describing associated objects and represents that three relationships may exist. For example, A and/or B may represent the following three cases: Only A exists, both A and B exist, and only B exists. In addition, in the descriptions of embodiments of this application, unless otherwise specified, “a plurality of” means two or more. In addition, to clearly describe the technical solutions in embodiments of this application, terms such as “first” and “second” are used in embodiments of this application to distinguish between same items or similar items whose functions and purposes are basically the same. A person skilled in the art may understand that the terms such as first and second do not limit a quantity and an execution sequence, and the terms such as first and second do not indicate a definite difference.

It should be noted that the “module” described in embodiments of this application may be a module established by a circuit, a function module implemented by a software program, or a module implemented jointly by a circuit and a software program. This is not limited in embodiments of this application.

It may be understood that each module may be an integrated module, or may be an independent module. This is not limited in embodiments of this application.

Generally, a small cell system may include three parts: a central unit, a converging unit, and a remote unit. A distance between the central unit and the converging unit may be in the order of kilometers. A distance between the converging unit and the remote unit may be in the order of hundreds of meters. The central unit and the converging unit may transmit a digital signal over an optical fiber through a common public radio interface (CPRI). The converging unit and the remote unit may transmit a digital signal through a CPRI port, or may transmit an intermediate-frequency analog signal through a cable.

For example, in a conventional Lampsite system and a Qcell system, a central unit includes a baseband processing module. A converging unit includes an interface protocol digital processing module. A remote unit includes a digital processing module, an analog to digital converter (ADC), a digital to analog converter (DAC), an intermediate and/or radio frequency module, a duplexer, and an antenna.

In a conventional Dot system, a central unit includes a baseband processing module. A converging unit includes an interface protocol digital processing module, an ADC, a DAC, and an intermediate and/or radio frequency module. A remote unit includes an intermediate and/or radio frequency module, a duplexer, and an antenna.

It can be learned that in the foregoing three conventional small cell systems, the Dot system moves down the digital processing module, the ADC module, and the DAC module of the remote unit in the Lampsite system and the Qcell system to the converging unit, thereby reducing a quantity of function modules of the remote unit, and increasing function modules of the converging unit.

However, the foregoing three conventional small cell systems have a common feature. In other words, a central unit outputs a digital signal to a remote unit. Due to possible reasons such as retransmission or buffering in digital signal transmission, when the central unit is connected to a plurality of remote units, the remote units are usually not synchronized, so it is difficult for a small cell system in the conventional technology to implement a distributed MIMO function.

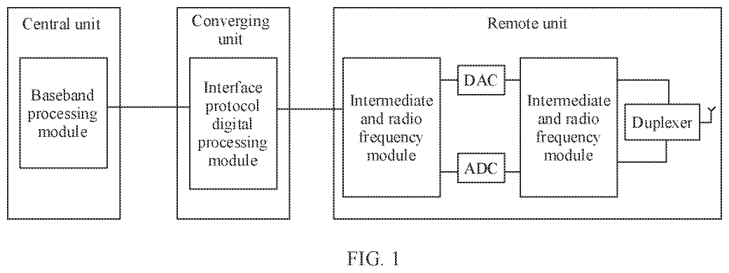

For example, FIG. 1 shows a conventional Lampsite system or a Qcell system.

In a small cell system, a central unit includes a baseband processing module. A converging unit includes an interface protocol digital processing module. A remote unit includes a digital processing module, an ADC, a DAC, an intermediate and/or radio frequency module, a duplexer, and an antenna.

In a transmit link, the baseband processing module of the central unit may generate a baseband signal. The baseband signal is transmitted to the converging unit through an optical CPRI port. The interface protocol digital processing module of the converging unit receives the signal and transmits the signal to the remote unit through the optical CPRI port. The digital processing module of the remote unit demodulates the signal. The demodulated signal is converted into an analog signal through the DAC. The analog signal is converted to a radio frequency signal at a corresponding frequency through the intermediate and/or radio frequency module. The radio frequency signal is transmitted through the duplexer and the antenna.

In a receive link, the antenna of the remote unit receives the signal. The received signal is transmitted to the receive link through the duplexer. The received signal is converted to a baseband or an intermediate frequency signal at a corresponding frequency through intermediate radio frequency conversion. The signal is converted into a digital signal through the ADC. The digital processing module transmits the digital signals to the converging unit through the optical CPRI port. The interface protocol digital processing module of the converging unit receives the signal, and transmits the received signal to the central unit through the optical CPRI port. The baseband processing module of the central unit demodulates the signal.

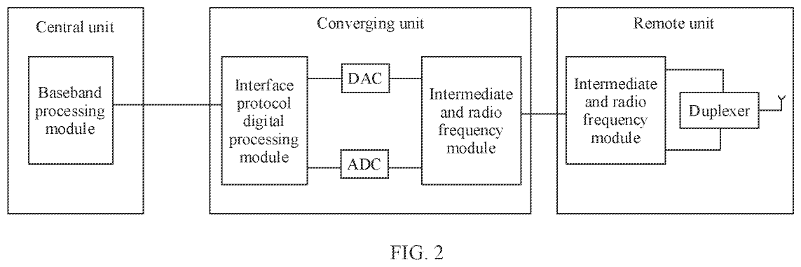

For example, FIG. 2 shows a conventional Dot system.

In a small cell system, a central unit includes a baseband processing module. A converging unit includes an interface protocol digital processing module, an ADC, a DAC, and an intermediate and/or radio frequency module. A remote unit includes an intermediate and/or radio frequency module, a duplexer, and an antenna.

In a transmit link, the baseband processing module of the central unit generates a baseband signal. The baseband signal is transmitted to the converging unit through an optical CPRI port. The interface protocol digital processing module of the converging unit receives the signal. The signal is converted into an analog signal through the DAC. The analog signal is converted to an intermediate frequency signal at a corresponding frequency through an intermediate frequency module. The intermediate frequency signal is transmitted to the remote unit through a cable. The radio frequency module of the remote unit converts the signal to a radio frequency signal at a corresponding frequency. The radio frequency signal is transmitted through the duplexer and the antenna.

In a receive link, the antenna of the remote unit receives a signal. The received signal is transmitted to the receive link through the duplexer. The received signal is converted to an intermediate frequency signal at a corresponding frequency through the radio frequency module. The signal is transmitted to the converging unit through a cable. The intermediate frequency module of the converging unit converts the signal to a baseband signal at the corresponding frequency. The signal is converted into a digital signal through the ADC. The interface protocol digital processing module of the converging unit receives the signal, and transmits the signal to the central unit through an optical CPRI port. The baseband processing module of the central unit demodulates the signal.

It can be learned that, in the conventional small cell system shown in FIG. 1 or FIG. 2, structures of a remote unit and a converging unit are complex, resulting in large volumes, weights, power consumption, and the like of the remote unit and the converging unit. In addition, a central unit transmits a digital signal to the remote unit. Due to possible reasons such as retransmission or buffering in digital signal transmission, when the central unit is connected to a plurality of remote units, the remote units are usually not synchronized, so it is difficult for a small cell system in the conventional technology to implement a distributed MIMO function.

In view of this, in a small cell system provided in embodiments of this application, a digital-to-analog conversion DAC module and an analog-to-digital conversion ADC module are disposed in a central unit, so that the central unit transmits an analog optical signal to a remote unit. When the central unit transmits the analog optical signal to a plurality of remote units, because a processing delay of an analog component in analog transmission is usually at a nanosecond level, and a total delay formed by a path transmission delay and the processing delay fluctuates slightly or even is fixed, synchronization of the plurality of remote units can be easily implemented in the central unit through calibration. Therefore, it is possible to easily implement a distributed MIMO function.

It may be understood that in embodiments of this application, the DAC module and the ADC module are moved down to the central unit, so that a very simple remote unit may be disposed in the small cell system and a very simple converging unit may be optionally disposed in the small cell system. Therefore, volume, weight, power consumption, and the like of the remote unit and the converging unit can be small, and performance of the remote unit and the converging unit can be further improved.

In a specific application, the small cell system in embodiments of this application may be named after an original small cell system, for example, may be defined as a Lampsite system, a Qcell system, or a Dot system. It may be understood that the small cell system in embodiments of this application may alternatively be adaptively named in another manner, for example, named as a system A or a system B. This is not limited in embodiments of this application.

For example, the small cell system in embodiments of this application corresponds to the conventional Lampsite system. The central unit in embodiments of this application may correspond to a base band unit (BBU) part of the Lampsite system. The converging unit may correspond to an indoor device (RHUB) part of the LampSite system, and the remote unit may correspond to an indoor remote radio unit (pRRU) part of the Lampsite system.

By using specific embodiments, the following describes in detail the technical solutions of this application and how to resolve the foregoing technical problem by using the technical solutions of this application. The following specific embodiments may be independent of each other or may be combined with each other, and a same or similar concept or process may not be described in detail in some embodiments.

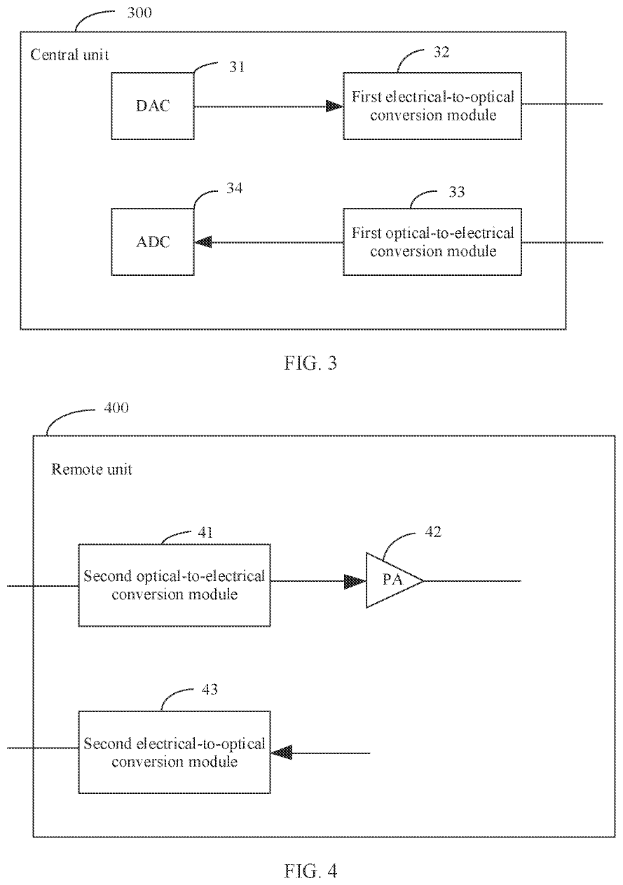

FIG. 3 is a schematic diagram depicting a structure of a central unit 300 according to an embodiment of this application. As shown in FIG. 3, the central unit 300 includes a digital-to-analog conversion DAC module 31, an analog-to-digital conversion ADC module 34, a first electrical-to-optical conversion module 32, and a first optical-to-electrical conversion module 33.

The DAC module 31 is configured to convert a baseband signal into a first analog electrical signal, where the first analog electrical signal is a zero frequency signal, an intermediate frequency signal, or a radio frequency signal. The first electrical-to-optical conversion module 32 is configured to convert the first analog electrical signal into a first optical signal, and output the first optical signal to a remote unit. The first optical-to-electrical conversion module 33 is configured to convert a second optical signal received from the remote unit into a second analog electrical signal, where the second analog electrical signal is a zero frequency signal, an intermediate frequency signal, or a radio frequency signal. The ADC module 34 is configured to convert the second analog electrical signal into a digital signal.

In embodiments of this application, the baseband signal may be generated by the central unit 300, or may be received by the central unit from another device. For example, the central unit 300 may further include a baseband processing module, and the baseband processing module may generate the baseband signal.

The baseband signal may be a digital signal, and specific content of the baseband signal may vary based on different application scenarios. The baseband signal is not limited in embodiments of this application.

In a transmit link of the central unit, the baseband signal may be used as an input of the DAC module 31. After performing analog-to-digital conversion on the baseband signal, the DAC module 31 may output the first analog electrical signal. The first analog electrical signal may be the zero frequency signal, the intermediate frequency signal, or the radio frequency signal. This is not limited in embodiments of this application.

The first analog electrical signal may be used as an input of the first electrical-to-optical conversion module 32. The first electrical-to-optical conversion module 32 may be an electrical-to-optical conversion module configured to convert an analog signal. After converting the first analog electrical signal, the first electrical-to-optical conversion module may output the first optical signal to the remote unit.

It may be understood that, in an actual application, an output end of the first electrical-to-optical conversion module 32 may communicate with the remote unit through an optical fiber, a converging unit, or the like, and the first optical signal may be transmitted to the remote unit through the optical fiber or the converging unit. A process of outputting the first optical signal to the remote unit is described in detail in a subsequent embodiment, and details are not described herein again.

It should be noted that in embodiments of this application, the first optical signal may be output to one or more remote units. In other words, a quantity of remote units may be determined based on an actual application scenario. This is not limited in embodiments of this application.

In addition, because the first electrical-to-optical conversion module 32 outputs an optical signal converted from an analog electrical signal, and processing delay of an analog component in analog transmission is usually at a nanosecond level, and a total delay formed by a path transmission delay and a processing delay fluctuates slightly or even is fixed, synchronization of the plurality of remote units can be easily implemented in the central unit through calibration. Therefore, it is possible to easily implement a distributed MIMO function.

In a receive link of the central unit, the first optical-to-electrical conversion module 33 may receive the second optical signal from the remote unit. For example, the remote unit may receive, from a terminal device through an antenna or the like, a signal sent by the terminal device, and then convert the signal sent by the terminal device into the second optical signal, and transmit the second optical signal to the first optical-to-electrical conversion module 33 of the central unit 300 through an optical fiber or a converging unit.

The first optical-to-electrical conversion module 33 converts the second optical signal, and outputs the second analog electrical signal. The second analog electrical signal may be a zero frequency signal, an intermediate frequency signal, or a radio frequency signal. This is not limited in embodiments of this application.

The second analog electrical signal may be used as an input of the ADC module 34. After performing analog-to-digital conversion on the second analog signal, the ADC module 34 may obtain a digital signal. The central unit may further process the digital signal adaptively based on an actual requirement. This is not limited in embodiments of this application.

In conclusion, in a small cell system in the conventional technology, a central unit transmits a digital signal to a remote unit. Due to possible reasons such as retransmission or buffering in digital signal transmission, when the central unit is connected to a plurality of remote units, the remote units are usually not synchronized, so it is difficult for a small cell system in the conventional technology to implement a MIMO function. In the small cell system in embodiments of this application, the digital-to-analog conversion DAC module and the analog-to-digital conversion ADC module are disposed in the central unit, so that the central unit transmits an analog optical signal to the remote unit. When the central unit transmits the analog optical signal to a plurality of remote units, because a processing delay of an analog component in analog transmission is usually at a nanosecond level, and a total delay formed by a path transmission delay and the processing delay fluctuates slightly or even is fixed, synchronization of the plurality of remote units can be easily implemented in the central unit through calibration. Therefore, it is possible to easily implement a distributed MIMO function.

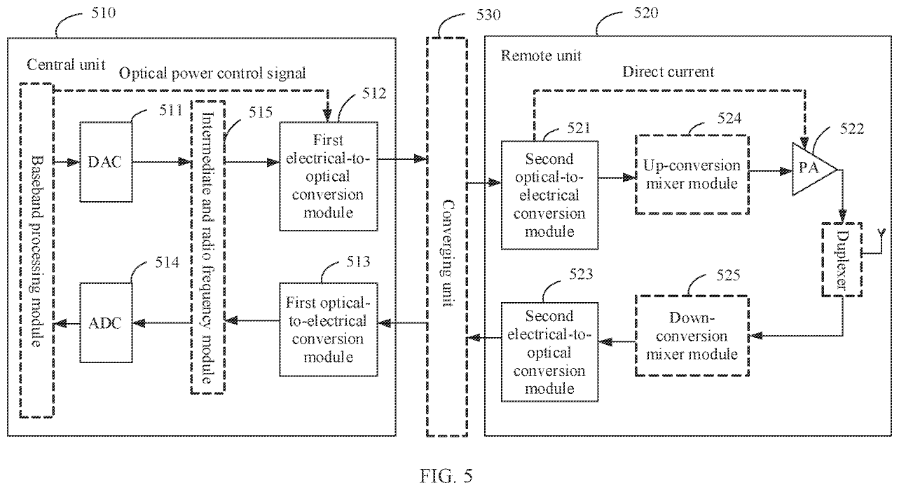

FIG. 4 is a schematic diagram depicting a structure of a remote unit 400 according to an embodiment of this application. As shown in FIG. 4, the remote unit 400 includes a second optical-to-electrical conversion module 41, a second electrical-to-optical conversion module 43, and an amplifier 42.

The second optical-to-electrical conversion module 41 is configured to convert a third optical signal received from a central unit into a third analog electrical signal. The third optical signal is an optical signal obtained by converting an analog electrical signal. The third analog electrical signal is a zero frequency signal, an intermediate frequency signal, or a radio frequency signal. The amplifier 42 is configured to amplify the third analog electrical signal. The second electrical-to-optical conversion module 43 is configured to convert a fourth analog electrical signal into a fourth optical signal, and output the fourth optical signal to the central unit. The fourth analog electrical signal is a zero frequency signal, an intermediate frequency signal, or a radio frequency signal.

In embodiments of this application, the remote unit 400 may receive the third optical signal from the central unit. For example, the third optical signal may be output by using the first electrical-to-optical conversion module in the embodiment in FIG. 3, and details are not described herein again.

The second optical-to-electrical conversion module 41 performs optical-to-electrical conversion on the third optical signal, and outputs the third analog electrical signal. The third analog electrical signal is a zero frequency signal, an intermediate frequency signal, or a radio frequency signal. This is not limited in embodiments of this application.

The third analog electrical signal may be used as an amplifier (it may also be referred to as a power amplifier (PA)) 42. The amplifier 42 may amplify the third analog electrical signal. An amplification multiple of the amplifier 42 may be a fixed value, or may be adjustable, and may be flexibly adjusted according to an actual requirement. This is not limited in embodiments of this application.

It should be noted that in embodiments of this application, a simple remote unit is constructed, and the remote unit may not include an ADC module, a DAC module, and a digital processing module. Therefore, the remote unit may not be able to control the amplification multiple of the amplifier 42 by using numerical control of the remote unit. Therefore, in actual application, if the amplification multiple of the amplifier 42 needs to be adjusted, the amplification multiple of the amplifier 42 may be controlled through the central unit. This will be described in detail in subsequent embodiments, and details are not described herein again.

Optionally, the analog electrical signal amplified by the amplifier 42 may be further transmitted through an antenna or the like. This is not limited in embodiments of this application.

The fourth analog electrical signal may be an analog electrical signal received by a remote unit 500 through an antenna or the like. The fourth analog electrical signal may be a zero frequency signal, an intermediate frequency signal, or a radio frequency signal. This is not limited in embodiments of this application.

The fourth analog electrical signal may be used as an input of the second electrical-to-optical conversion module 43. The second electrical-to-optical conversion module 43 performs electrical-to-optical conversion on the fourth analog electrical signal, and outputs a fourth optical signal. Further, the fourth optical signal may be transmitted to the central unit through an optical fiber, a converging unit, or the like. Specific implementation of outputting the fourth optical signal to the central unit is described in detail in subsequent embodiments, and details are not described herein again.

In embodiments of this application, the remote unit has a simple structure, and may include fewer modules. Therefore, the remote unit may be conveniently disposed in a small cell system.

FIG. 5 is a schematic diagram depicting a structure of a small cell system according to an embodiment of this application. As shown in FIG. 5, the small cell system includes a central unit 510 and a remote unit 520.

For a DAC module 511, an ADC module 514, a first electrical-to-optical conversion module 512, and a first optical-to-electrical conversion module 513 in the central unit 510, refer to descriptions in the embodiment corresponding to FIG. 3. For a second optical-to-electrical conversion module 521, a second electrical-to-optical conversion module 523, and an amplifier 522 in the remote unit 520, refer to descriptions in the embodiment corresponding to FIG. 4. Details are not described herein again.

Optionally, the central unit 510 and the remote unit 520 may be connected through an optical fiber transmit link. To be specific, the small cell system 500 in embodiments of this application may not include a converging unit, thereby reducing device types in the small cell system.

Alternatively, the central unit 510 and the remote unit 520 may be connected through a converging unit 530, to implement convenient remote unit access and the like by using the converging unit 530 that is close to the remote unit. For example, 100 optical fibers may be disposed between the central unit 510 and the converging unit 530. In actual application, there may be only 30 remote units. In this case, after the 30 remote units are connected to the converging unit, 70 optical fibers are reserved in the converging unit. Therefore, when a remote unit needs to be added subsequently, access may be adapted in the converging unit, and the central unit 510 does not need to be adjusted.

Optionally, as shown in FIG. 5, the central unit further includes an intermediate and/or radio frequency module 515.

The intermediate and/or radio frequency module 515 is configured to convert a first analog electrical signal into an electrical signal at a first frequency. The first electrical-to-optical conversion module 512 is configured to convert the electrical signal at the first frequency into a first optical signal, and output the first optical signal to the remote unit.

In embodiments of this application, the intermediate and/or radio frequency module 515 may convert the first analog electrical signal on a transmit link into an electrical signal at the first frequency. For example, the first frequency may include 2.4 GHz, 3 GHz, 5 GHz, or the like.

It may be understood that the first frequency may be determined based on an actual application scenario. For example, when a value of the first frequency is high, a harmonic spacing of the electrical signal is large and easy to filter, and signal quality is good. However, when the value of the first frequency is high, the first electrical-to-optical conversion module 512 has a high performance requirement. This increases costs of the first electrical-to-optical conversion module 512. When the value of the first frequency is low, the first electrical-to-optical conversion module 512 has a low performance requirement, and costs of the first electrical-to-optical conversion module 512 are not increased. However, a harmonic spacing of the electrical signal is small, interference is easy to cause, and signal quality is poor.

In a receive link, the intermediate and/or radio frequency module 515 may convert the second analog electrical signal into an electrical signal at a second frequency. The ADC module 514 is configured to convert an analog electrical signal at the second frequency into the digital signal.

In embodiments of this application, the second frequency may be the same as the first frequency, or may be different from the first frequency. A specific value of the second frequency may be adaptively set based on performance of the ADC module 514 or the like. This is not limited in embodiments of this application.

Optionally, the remote unit 520 further includes an up-conversion mixer module 524 and a down-conversion mixer module 525.

In embodiments of this application, in a transmit link of the small cell system, the up-conversion mixer module 524 may be configured to convert the third analog electrical signal into an electrical signal at a third frequency. The amplifier 522 is configured to amplify the electrical signal at the third frequency.

In embodiments of this application, the third frequency may be adaptively set based on a frequency actually required when the remote unit sends an electrical signal. This is not limited in embodiments of this application.

The down-conversion mixer module 525 is configured to convert a fourth analog electrical signal into an electrical signal at a fourth frequency. The second electrical-to-optical conversion module 523 is configured to convert the electrical signal at the fourth frequency into a fourth optical signal, and output the fourth optical signal to the central unit. For example, the fourth frequency may include 2.4 GHz, 3 GHz, 5 GHz, or the like.

It may be understood that the fourth frequency may be determined based on an actual application scenario. For example, when a value of the fourth frequency is high, a harmonic spacing of the electrical signal is large and easy to filter, and signal quality is good. However, when the value of the fourth frequency is high, the second electrical-to-optical conversion module 523 has a high performance requirement. This increases costs of the second electrical-to-optical conversion module 523. When the value of the fourth frequency is low, the second electrical-to-optical conversion module 523 has a low performance requirement, and costs of the second electrical-to-optical conversion module 523 are not increased. However, a harmonic spacing of the electrical signal is small, interference is easy to cause, and signal quality is poor.

The value of the third frequency and the value of the fourth frequency may be the same or different. This is not limited in embodiments of this application.

It should be noted that in embodiments of this application, in the small cell system, the intermediate and/or radio frequency module 515, the up-conversion mixer module 524, and the down-conversion mixer module 525 may be adaptively disposed or not disposed based on an actual application scenario. This is not limited in embodiments of this application.

For example, in a scenario, there is no intermediate and/or radio frequency module in the central unit, and there is an up-conversion mixer module in the remote unit. For example, an output frequency range of the DAC of the central unit is 0.20 GHz to 0.22 GHz, and the up-mixer module of the remote unit converts a signal to 2.4 GHz to 2.42 GHz. In another scenario, there is an intermediate and/or radio frequency module in the central unit, and there is no up-conversion mixer module in the remote unit. For example, an output frequency range of the DAC of the central unit is 0.20 GHz to 0.22 GHz, and the intermediate and/or radio frequency module of the central unit converts a signal to 2.4 GHz to 2.42 GHz. In still another scenario, there is an intermediate and/or radio frequency module in the central unit, and there is an up-conversion mixer module in the remote unit. For example, an output frequency range of the DAC of the central unit is 0.20 GHz to 0.22 GHz, and the intermediate and/or radio frequency module of the central unit converts a signal to 1.4 GHz to 1.42 GHz, and the up-mixer module of the remote unit converts a signal to 2.4 GHz to 2.42 GHz.

Optionally, the central unit is further configured to input an optical power control signal to the first electrical-to-optical conversion module 512. The first electrical-to-optical conversion module 512 is further configured to output optical power related to the optical power control signal, where the optical power is used to control an amplification multiple of an amplifier in the remote unit.

In embodiments of this application, the central unit may change an output direct current of the second optical-to-electrical conversion module 521 of the remote unit by controlling the output optical power of the first electrical-to-optical conversion module 512, and further control an amplification multiple of a PA in the remote unit by using the direct current.

In embodiments of this application, because a remote unit that does not include a digital processing module may be constructed, the remote unit may not be able to control an amplification multiple of a PA. In this case, the amplifier in the remote unit may be controlled based on the optical power control signal output by the central unit. For example, the optical power control signal may be generated by a baseband processing module in the central unit.

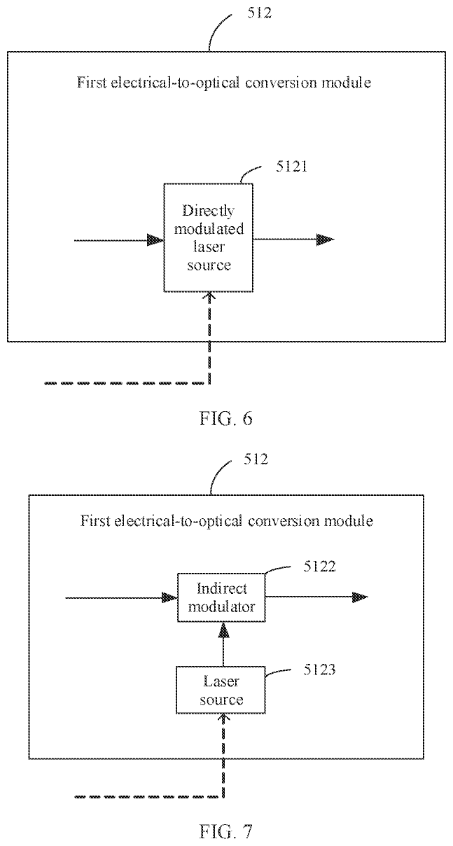

For example, as shown in FIG. 6, the first electrical-to-optical conversion module 512 includes a directly modulated laser source 5121, and the optical power control signal is a direct current bias current. The central unit is further configured to input the direct current bias current to the directly modulated laser source.

In embodiments of this application, the first electrical-to-optical conversion module uses a manner of directly modulating the laser source. The optical power control signal is the direct current bias current to adjust the directly modulated laser source. Output optical power of the first electrical-to-optical conversion module may be adjusted based on the direct current bias current.

For example, as shown in FIG. 7, the first electrical-to-optical conversion module 512 includes an indirect modulator 5122 and a laser source 5123. The optical power control signal is a direct current bias current. The central unit is further configured to input the direct current bias current to the laser source.

In embodiments of this application, the first electrical-to-optical conversion module uses a manner of the laser source and the indirect modulator. The optical power control signal is the direct current bias current of the laser source. Output optical power of the first electrical-to-optical conversion module may be adjusted based on the direct current bias current, to adjust the output optical power of the indirect modulator.

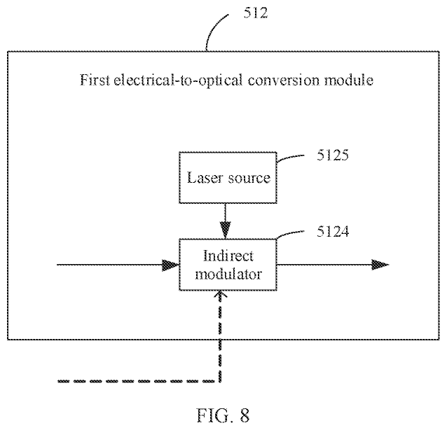

For example, as shown in FIG. 8, the first electrical-to-optical conversion module 512 includes an indirect modulator 5124 and a laser source 5125. The optical power control signal is a bias voltage, and the central unit is further configured to input the bias voltage to the indirect modulator.

In embodiments of this application, the first electrical-to-optical conversion module uses a manner of the laser source and the indirect modulator. The optical power control signal is the bias voltage to adjust the indirect modulator. Output optical power of the first electrical-to-optical conversion module may be adjusted based on the bias voltage.

Adaptively, in the remote unit, the second optical-to-electrical conversion module 521 is further configured to convert optical power related to the optical power control signal into a direct current. The amplifier 522 is further configured to amplify the third analog electrical signal by using an amplification multiple related to the direct current.

It may be understood that, in an actual application, a digital signal transmit link may be further established between the central unit 510 and the remote unit 520. The transmit link may be used to transmit a digital signal that controls the amplification multiple of the amplifier 522, to control the amplification multiple of the amplifier in the remote unit. This is not limited in embodiments of this application.

For example, in the small cell system including an optional module shown in FIG. 5, a signal processing process may be as follows.

In a Transmit Link:

In the central unit, the baseband processing module generates a baseband signal. The baseband signal is converted into an analog electrical signal through the DAC module. The analog electrical signal is converted into a zero frequency electrical signal, an intermediate frequency electrical signal, or a radio frequency electrical signal by the optional intermediate and/or radio frequency module. The intermediate frequency electrical signal or the radio frequency electrical signal is converted into an optical domain by using the first electrical-to-optical conversion module, to obtain an optical signal.

The optical signal is transmitted through an optical fiber, and then transmitted to the remote unit through an optional converging unit.

In the remote unit, the second optical-to-electrical conversion module converts the optical signal into an analog electrical signal. The analog electrical signal is converted to a specified frequency through an optional up-conversion mixer module.

In the remote unit, the analog electrical signals are amplified by the PA, and the amplified signal is transmitted through the duplexer and antenna.

Optionally, in the central unit, the baseband processing module sends an optical power control signal to control output optical power of the first electrical-to-optical conversion module. Adaptively, in the remote unit, a direct current output of the second optical-to-electrical conversion module is used to control an amplification multiple of the PA.

In a Receive Link:

In the remote unit, the antenna receives an analog electrical signal. The analog electrical signal is transmitted to the receive link through the duplexer. The analog electrical signal is converted to a specified frequency through an optional down-conversion mixer module. The analog electrical signal is converted into the optical domain by using the second electrical-to-optical conversion module, to obtain an optical signal.

The optical signal is transmitted through an optical fiber, and then transmitted to the central unit through the optional converging unit.

In the central unit, the first optical-to-electrical conversion module converts the optical signal into an analog electrical signal. The analog electrical signal is converted to a specified frequency through an optional intermediate and/or radio frequency module. The analog electrical signal is converted into a digital signal through an ADC module. The digital signal is demodulated by the baseband processing module.

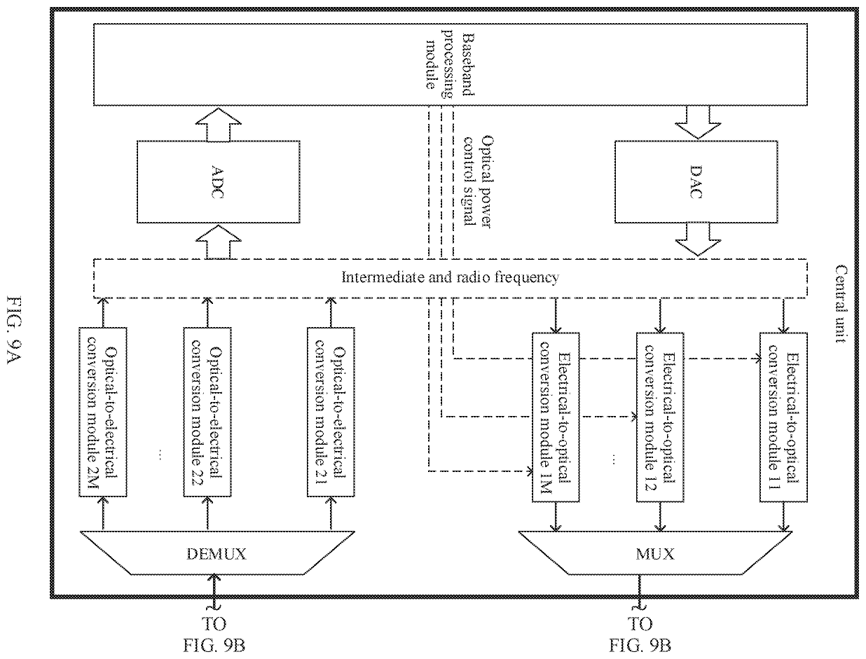

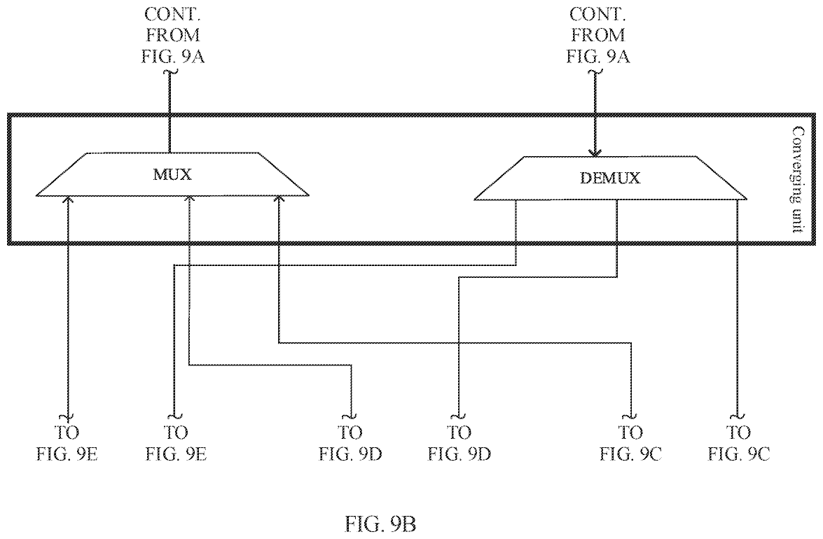

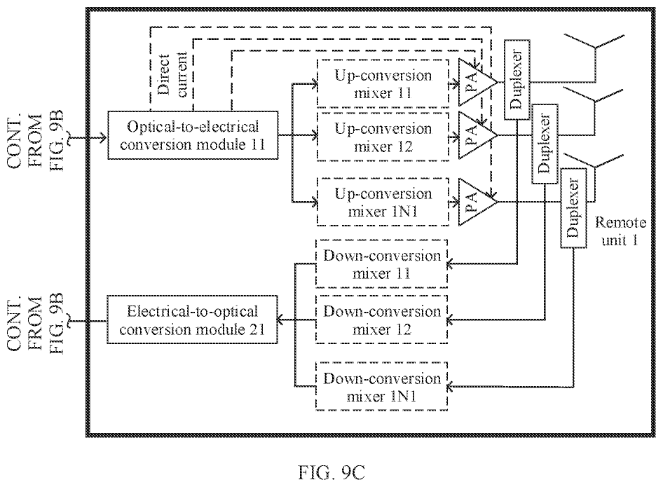

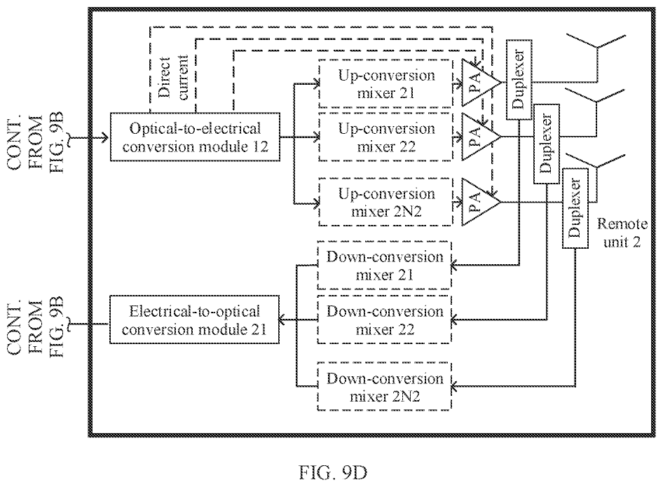

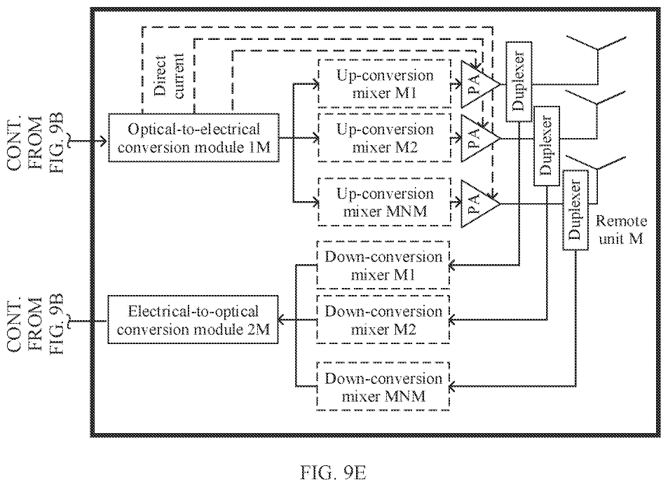

Optionally, the small cell system may include a plurality of remote units. For example, FIG. 9A to FIG. 12D show four example schematic diagrams of structures in which a small cell system includes a plurality of remote units.

It should be noted that, in actual application, a baseband processing module in a central unit may be referred to as a baseband processing unit. This is not limited in embodiments of this application.

Optionally, FIG. 9A to FIG. 9E are schematic diagrams depicting a structure of a specific small cell system according to an embodiment of this application.

As shown in FIG. 9A to FIG. 9E, the small cell system includes a central unit, a converging unit, and M remote units.

A first electrical-to-optical conversion module is configured to convert M first analog electrical signals into M first optical signals, and output the M first optical signals to the remote unit, where M is an integer greater than or equal to 1. A first optical-to-electrical conversion module is configured to convert N second optical signals received from the remote unit into N second analog electrical signals, where N is an integer greater than or equal to 1.

In embodiments of this application, the first electrical-to-optical conversion module may be M independent electrical-to-optical conversion modules, or may be a module in which the M electrical-to-optical conversion modules are integrated, or may be K modules integrated by M electrical-to-optical conversion modules. For example, M is 100, every four of the 100 electrical-to-optical conversion modules are integrated, and K=25. Specific values of M and K may be set based on an actual application scenario. This is not limited in embodiments of this application.

In embodiments of this application, the first optical-to-electrical conversion module may be N independent optical-to-electrical conversion modules, or may be a module in which the N optical-to-electrical conversion modules are integrated, or may be L modules integrated by N optical-to-electrical conversion modules. For example, N is 100, every four of the 100 electrical-to-optical conversion modules are integrated, and L=25. Specific values of N and L may be set based on an actual application scenario. This is not limited in embodiments of this application.

It should be noted that M and N may be the same or different. In FIG. 9A to FIG. 9E, an example in which M and N are the same is used, and values of M and N are not limited.

Optionally, the central unit further includes a first wavelength division multiplexer (MUX). The first MUX is configured to combine the M first optical signals and output the signal to the remote unit.

Optionally, the central unit further includes a first demultiplexer (DEMUX). The first DEMUX is configured to split the N second optical signals and output the split second optical signals to the first optical-to-electrical conversion module.

Optionally, the converging unit includes a second demultiplexer MUX and a second demultiplexer DEMUX. The second DEMUX is configured to split the optical signal combined by the first MUX of the central unit, and output the split optical signals to one or more remote units.

In embodiments of this application, because there are the first MUX and the first DEMUX in the central unit, and there are the second MUX and the second DEMUX in the converging unit, when the central unit transmits a signal to the converging unit, a transmit link or a receive link may be implemented by using one optical fiber, and a communication link between the central unit and the converging unit is simple.

For example, in the small cell system shown in FIG. 9A to FIG. 9E, a signal processing process may be as follows.

In a Transmit Link:

In the central unit, the baseband processing module generates M baseband signals. The M baseband signals are converted into M analog electrical signals through the DAC module. The M analog electrical signals are converted into zero frequency electrical signals, intermediate frequency electrical signals, or radio frequency electrical signals by an optional intermediate and/or radio frequency module. The M zero frequency signals, intermediate frequency signals, or radio frequency electrical signals are converted to optical signals at different wavelengths through an electrical-to-optical conversion module 11, an electrical-optical conversion module 12 . . . , and an electrical-optical conversion module 1M. M optical signals are combined through an MUX. The combined optical signal is transmitted to the converging unit through an optical fiber.

In the converging unit, a DEMUX splits optical signals at different wavelengths into M channels. The split M optical signals respectively enter a remote unit 1, a remote unit 2 . . . , and a remote unit M.

In each remote unit, the optical-to-electrical conversion module converts an optical signal into an analog electrical signal. The analog electrical signal is converted to a specified frequency through an optional up-conversion mixer module. The analog electrical signal is amplified by a PA. The amplified signal is transmitted through a duplexer and an antenna.

Optionally, in the central unit, the baseband processing module sends M optical power control signals, and the M optical power control signals respectively control output optical power of the electrical-to-optical conversion module 11, the electrical-to-optical conversion module 12 . . . , and the electrical-to-optical conversion module 1M. In each remote unit, an optical-to-electrical conversion module controls an amplification multiple of a PA based on a direct current output of an optical power control signal.

In a receive link.

In each remote unit, the antenna receives an analog electrical signal. The analog electrical signal is transmitted to the receive link through the duplexer. The analog electrical signal is converted to a specified frequency through an optional down-conversion mixer module. The analog electrical signal is converted into an optical signal through the electrical-to-optical conversion module. The optical signal is transmitted to the converging unit through an optical fiber.

In the converging unit, the M optical signals are combined through an MUX. The combined optical signal is transmitted to the central unit through an optical fiber.

In the central unit, the DEMUX splits optical signals at different wavelengths into M channels. An optical-to-electrical conversion module 21, an optical-to-electrical conversion module 22 . . . , and an optical-to-electrical conversion module 2M convert an optical signal into an analog electrical signal. The analog electrical signal is converted to a specified frequency through an optional intermediate and/or radio frequency module. The analog electrical signal is converted into a digital signal through an ADC module. The digital signal is demodulated by the baseband processing module.

In embodiments of this application, a MIMO function may be implemented. For example, in the transmit link, analog electrical signals include signals of 0.4 GHz to 0.6 GHz and 0.8 GHz to 1 GHz. Signals of 0.4 GHz to 0.6 GHz may be converted into 2.4 GHz and transmitted to four antennas, and the signal of 0.8 GHz to 1 GHz signal may be converted into 3.5 GHz and transmitted to two antennas. In this way, the MIMO function is implemented.

It should be noted that in embodiments of this application, because a wavelength division multiplexer is used, wavelengths of electrical-to-optical conversion modules in the central unit need to be different, so that a combined signal can be correctly split.

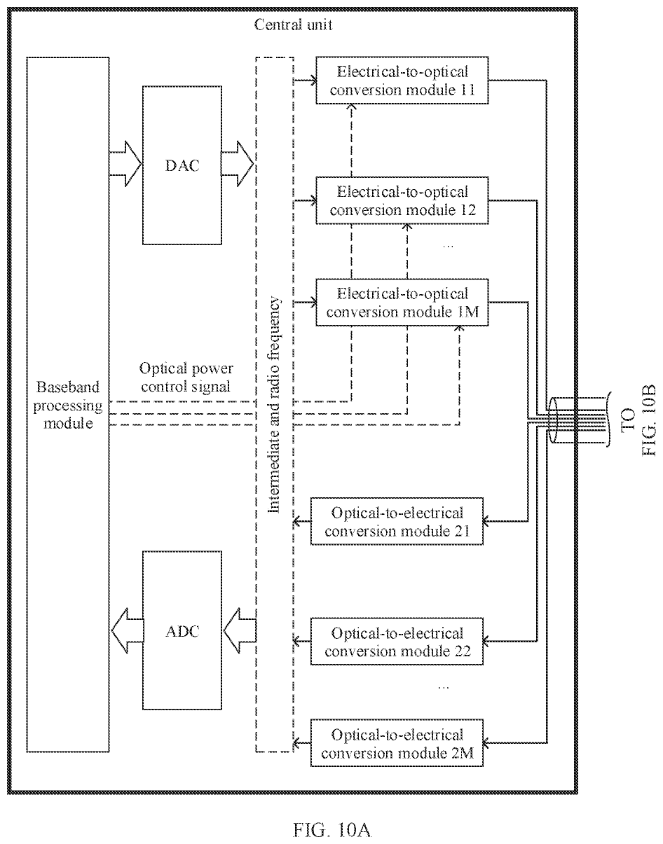

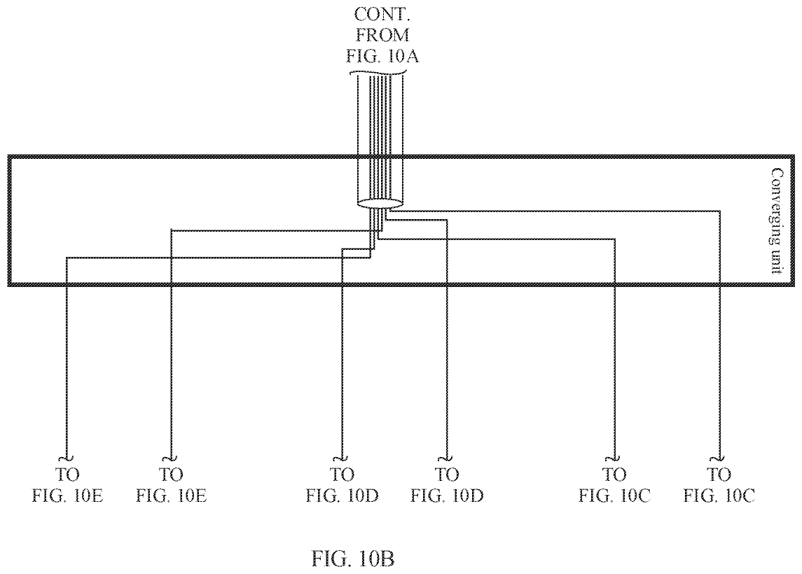

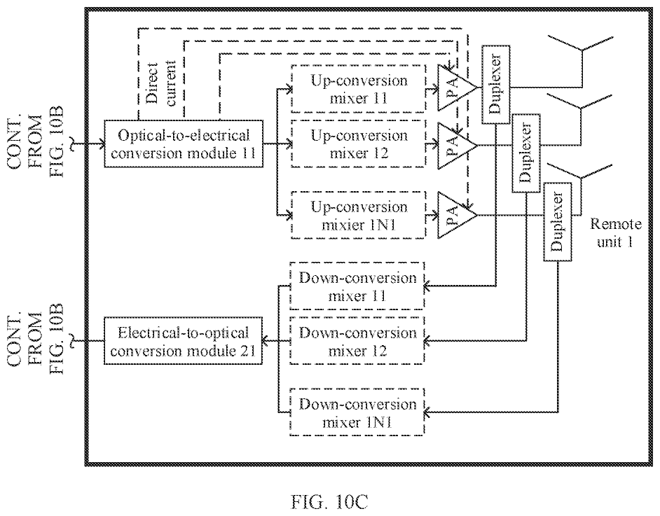

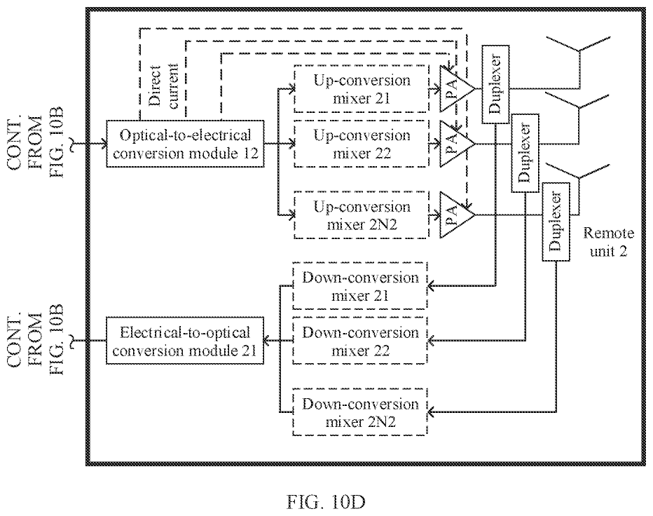

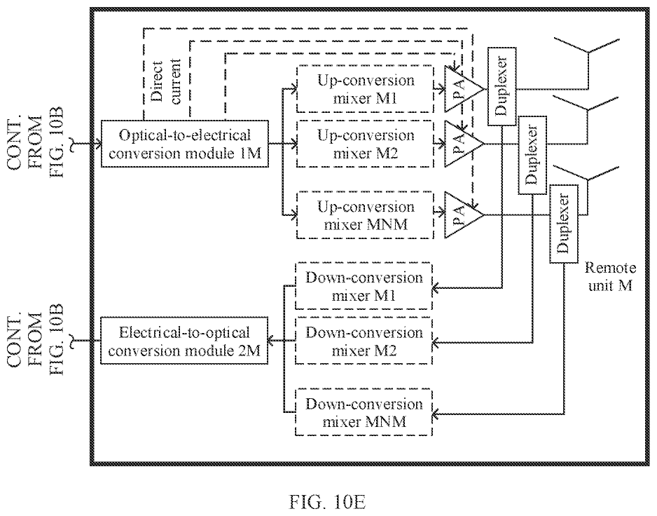

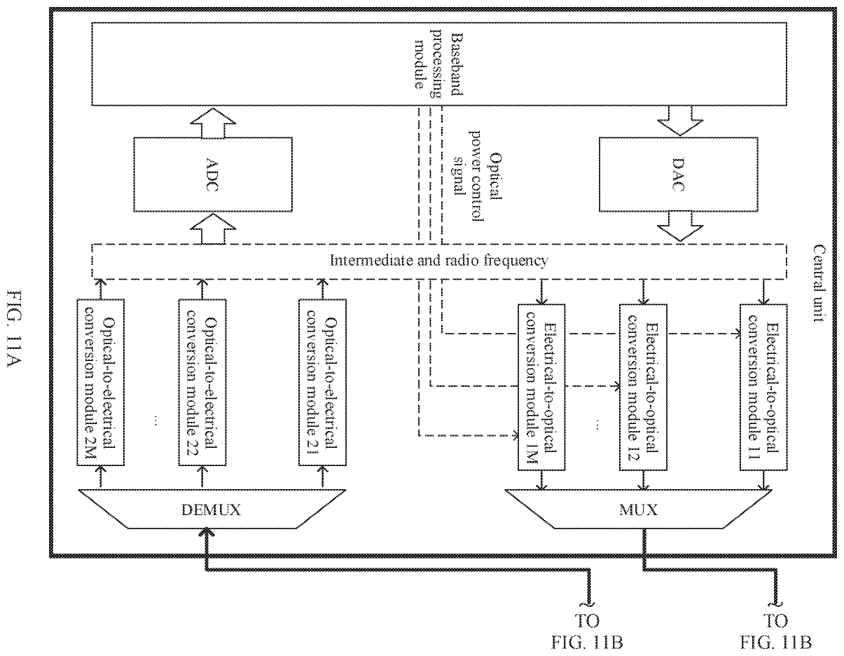

Optionally, FIG. 10A to FIG. 10E are schematic diagrams depicting a structure of another specific small cell system according to an embodiment of this application.

As shown in FIG. 10A to FIG. 10E, the small cell system includes a central unit, a converging unit, and M remote units.

A first electrical-to-optical conversion module is configured to convert M first analog electrical signals into M first optical signals, and output the M first optical signals to the remote unit, where M is an integer greater than or equal to 1. A first optical-to-electrical conversion module is configured to convert N second optical signals received from the remote unit into N second analog electrical signals, where N is an integer greater than or equal to 1.

In embodiments of this application, the first electrical-to-optical conversion module may be M independent electrical-to-optical conversion modules, or may be a module in which the M electrical-to-optical conversion modules are integrated, or may be K modules integrated by M electrical-to-optical conversion modules. For example, M is 100, every four of the 100 electrical-to-optical conversion modules are integrated, and K=25. Specific values of M and K may be set based on an actual application scenario. This is not limited in embodiments of this application.

In embodiments of this application, the first optical-to-electrical conversion module may be N independent optical-to-electrical conversion modules, or may be a module in which the N optical-to-electrical conversion modules are integrated, or may be L modules integrated by N optical-to-electrical conversion modules. For example, N is 100, every four of the 100 electrical-to-optical conversion modules are integrated, and L=25. Specific values of N and L may be set based on an actual application scenario. This is not limited in embodiments of this application.

It should be noted that M and N may be the same or different. In FIG. 10A to FIG. 10E, an example in which M and N are the same is used, and values of M and N are not limited.

In embodiments of this application, an electrical-to-optical conversion module of the central unit and the remote unit are connected through an optical fiber. Therefore, there may be electrical-to-optical conversion modules having a same output wavelength in the M electrical-to-optical conversion modules, and a performance requirement on the electrical-to-optical conversion modules is low. Therefore, cost overheads caused by disposing electrical-to-optical conversion modules with different wavelengths can be reduced.

Optionally, the optical fiber may be a multi-core optical fiber, an optical cable, or the like. The multi-core optical fiber refers to a plurality of fiber cores in a same optical fiber. The optical cable refers to a plurality of optical fibers combined into an optical cable. This reduces the complexity of route layout.

There may be optical-to-electrical conversion modules having a same output wavelength in the N optical-to-electrical conversion modules, and a performance requirement on the optical-to-electrical conversion modules is low. Therefore, cost overheads caused by disposing optical-to-electrical conversion modules with different wavelengths can be reduced.

For example, in the small cell system shown in FIG. 10A to FIG. 10E, a signal processing process may be as follows.

In a Transmit Link:

In the central unit, the baseband processing module generates M baseband signals. The M baseband signals are converted into M analog electrical signals through the DAC module. The M analog electrical signals are converted into zero frequency electrical signals, intermediate frequency electrical signals, or radio frequency electrical signals by an optional intermediate and/or radio frequency module. The M zero frequency signals, intermediate frequency signals, or radio frequency electrical signals are converted to optical signals through an electrical-to-optical conversion module 11, an electrical-optical conversion module 12 . . . , and an electrical-optical conversion module 1M. The M optical signals are transmitted to the converging unit through an optical fiber.

In the converging unit, M optical fibers are split. In other words, the M optical signals are split. The M optical signals respectively enter a remote unit 1, a remote unit 2 . . . , and a remote unit M.

In each remote unit, the optical-to-electrical conversion module converts an optical signal into an analog electrical signal. The analog electrical signal is converted to a specified frequency through an optional up-conversion mixer module. The analog electrical signal is amplified by a PA. The amplified signal is transmitted through a duplexer and an antenna.

Optionally, in the central unit, the baseband processing module sends M optical power control signals, and the M optical power control signals respectively control output optical power of the electrical-to-optical conversion module 11, the electrical-to-optical conversion module 12 . . . , and the electrical-to-optical conversion module 1M. In each remote unit, an optical-to-electrical conversion module controls an amplification multiple of a PA based on a direct current output of an optical power control signal.

In a Receive Link:

In each remote unit, the antenna receives an analog electrical signal. The analog electrical signal is transmitted to the receive link through the duplexer. The analog electrical signal is converted to a specified frequency through an optional down-conversion mixer module. The analog electrical signal is converted into an optical signal through the electrical-to-optical conversion module. The optical signal is transmitted to the converging unit through an optical fiber.

In the converging unit, the M optical signals are transmitted to the central unit through optical fibers.

M optical signals are split in the central unit. An optical-to-electrical conversion module 21, an optical-to-electrical conversion module 22 . . . , and an optical-to-electrical conversion module 2M convert an optical signal into an analog electrical signal. The analog electrical signal is converted to a specified frequency through an optional intermediate and/or radio frequency module. The analog electrical signal is converted into a digital signal through an ADC module. The digital signal is demodulated by the baseband processing module.

In embodiments of this application, a MIMO function may be implemented. For example, in the transmit link, analog electrical signals include signals of 0.4 GHz to 0.6 GHz and 0.8 to 1 GHz. A signal of 0.4 GHz to 0.6 GHz may be converted into 2.4 GHz and transmitted to four antennas, and the signal of 0.8 GHz to 1 GHz signal may be converted into 3.5 GHz and transmitted to two antennas. In this way, the MIMO function is implemented.

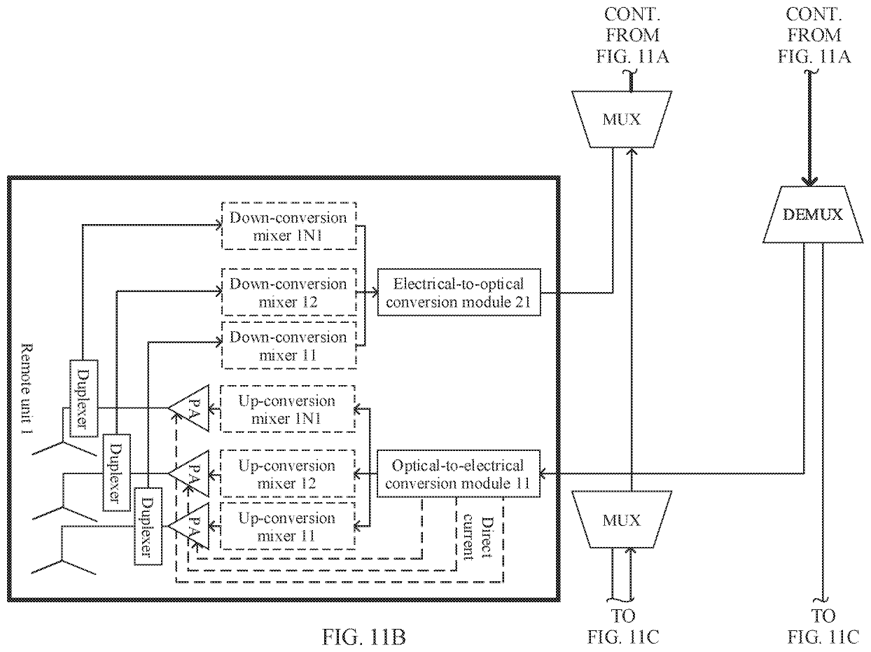

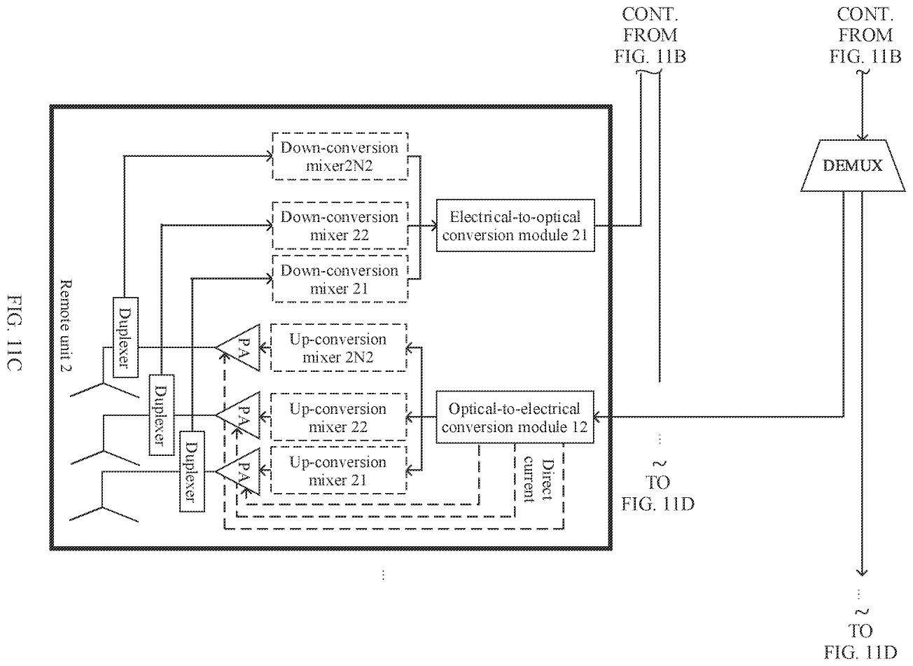

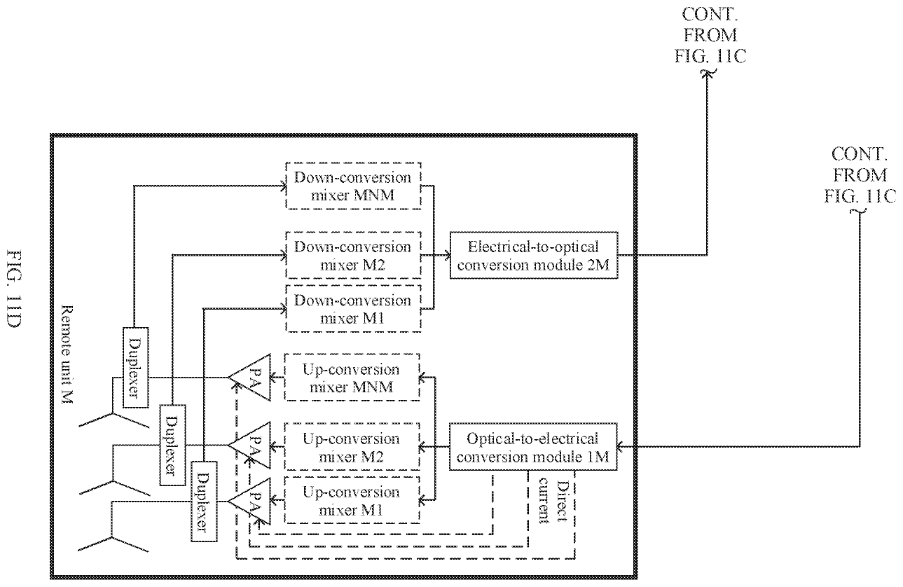

Optionally, FIG. 11A to FIG. 11D are schematic diagrams depicting a structure of still another specific small cell system according to an embodiment of this application.

As shown in FIG. 11A to FIG. 11D, the small cell system includes a central unit and M remote units.

A first electrical-to-optical conversion module is configured to convert M first analog electrical signals into M first optical signals, and output the M first optical signals to the remote unit, where M is an integer greater than or equal to 1. A first optical-to-electrical conversion module is configured to convert N second optical signals received from the remote unit into N second analog electrical signals, where N is an integer greater than or equal to 1.

In embodiments of this application, the first electrical-to-optical conversion module may be M independent electrical-to-optical conversion modules, or may be a module in which the M electrical-to-optical conversion modules are integrated, or may be K modules integrated by M electrical-to-optical conversion modules. For example, M is 100, every four of the 100 electrical-to-optical conversion modules are integrated, and K=25. Specific values of M and K may be set based on an actual application scenario. This is not limited in embodiments of this application.

In embodiments of this application, the first optical-to-electrical conversion module may be N independent optical-to-electrical conversion modules, or may be a module in which the N optical-to-electrical conversion modules are integrated, or may be L modules integrated by N optical-to-electrical conversion modules. For example, N is 100, every four of the 100 electrical-to-optical conversion modules are integrated, and L=25. Specific values of N and L may be set based on an actual application scenario. This is not limited in embodiments of this application.

It should be noted that M and N may be the same or different. In FIG. 11A to FIG. 11D, an example in which M and N are the same is used, and values of M and N are not limited.

The central unit and the M remote units are connected through an optical fiber transmit link.

Optionally, the central unit further includes a first wavelength division multiplexer MUX. The first MUX is configured to combine the M first optical signals and output the signal to the remote unit.

Optionally, the central unit further includes a first demultiplexer DEMUX. The first DEMUX is configured to split the N second optical signals and output the split second optical signals to the first optical-to-electrical conversion module.

Optionally, the optical fiber transmit link includes M third wavelength division multiplexers MUXs and M third demultiplexers DEMUXs. Any third DEMUX is configured to split, from an optical signal combined by a first MUX of the central unit, a target optical signal related to a remote unit connected to the any third DEMUX, and output the target optical signal to a remote unit connected to the any third DEMUX. Any third MUX is configured to combine optical signals received from a remote unit connected to any third MUX, and output the combined optical signal to a first DEMUX of the central unit.

In embodiments of this application, because there are the first MUX and the first DEMUX in the central unit, and there are M third MUXs and M third DEMUXs in the optical fiber transmit link, when the central unit transmits a signal to the remote unit, a transmit link or a receive link may be implemented by using one optical fiber, and a communication link between the central unit and the remote unit is simple.

For example, in the small cell system shown in FIG. 11A to FIG. 11D, a signal processing process may be as follows.

In a Transmit Link:

In the central unit, the baseband processing module generates M baseband signals. The M baseband signals are converted into M analog electrical signals through the DAC module. The M analog electrical signals are converted into zero frequency electrical signals, intermediate frequency electrical signals, or radio frequency electrical signals by an optional intermediate and/or radio frequency module. The M zero frequency signals, intermediate frequency signals, or radio frequency electrical signals are converted to optical signals at different wavelengths through an electrical-to-optical conversion module 11, an electrical-optical conversion module 12 . . . , and an electrical-optical conversion module 1M. M optical signals are combined through an MUX. The combined optical signal is transmitted through an optical fiber.

In the optical fiber transmit link, each DEMUX splits an optical signal at a wavelength corresponding to the remote unit. The split optical signals respectively enter a remote unit 1, a remote unit 2 . . . , and a remote unit M.

In each remote unit, the optical-to-electrical conversion module converts an optical signal into an analog electrical signal. The analog electrical signal is converted to a specified frequency through an optional up-conversion mixer module. The analog electrical signal is amplified by a PA. The amplified signal is transmitted through a duplexer and an antenna.

Optionally, in the central unit, the baseband processing module sends M optical power control signals, and the M optical power control signals respectively control output optical power of the electrical-to-optical conversion module 11, the electrical-to-optical conversion module 12 . . . , and the electrical-to-optical conversion module 1M. In each remote unit, an optical-to-electrical conversion module controls an amplification multiple of a PA based on a direct current output of an optical power control signal.

In a Receive Link:

In each remote unit, the antenna receives an analog electrical signal. The analog electrical signal is transmitted to the receive link through the duplexer. The analog electrical signal is converted to a specified frequency through an optional down-conversion mixer module. The analog electrical signal is converted into an optical signal through the electrical-to-optical conversion module.

In the optical fiber transmit link, optical signals at different wavelengths are combined by corresponding MUXs. The combined optical signal is transmitted to the central unit through an optical fiber.

In the central unit, the DEMUX splits optical signals at different wavelengths into M channels. An optical-to-electrical conversion module 21, an optical-to-electrical conversion module 22 . . . , and an optical-to-electrical conversion module 2M convert an optical signal into an analog electrical signal. The analog electrical signal is converted to a specified frequency through an optional intermediate and/or radio frequency module. The analog electrical signal is converted into a digital signal through an ADC module. The digital signal is demodulated by the baseband processing module.

In embodiments of this application, a MIMO function may be implemented. For example, in the transmit link, analog electrical signals include signals of 0.4 GHz to 0.6 GHz and 0.8 to 1 GHz. A signal of 0.4 GHz to 0.6 GHz may be converted into 2.4 GHz and transmitted to four antennas, and the signal of 0.8 GHz to 1 GHz may be converted into 3.5 GHz and transmitted to two antennas. In this way, the MIMO function is implemented.

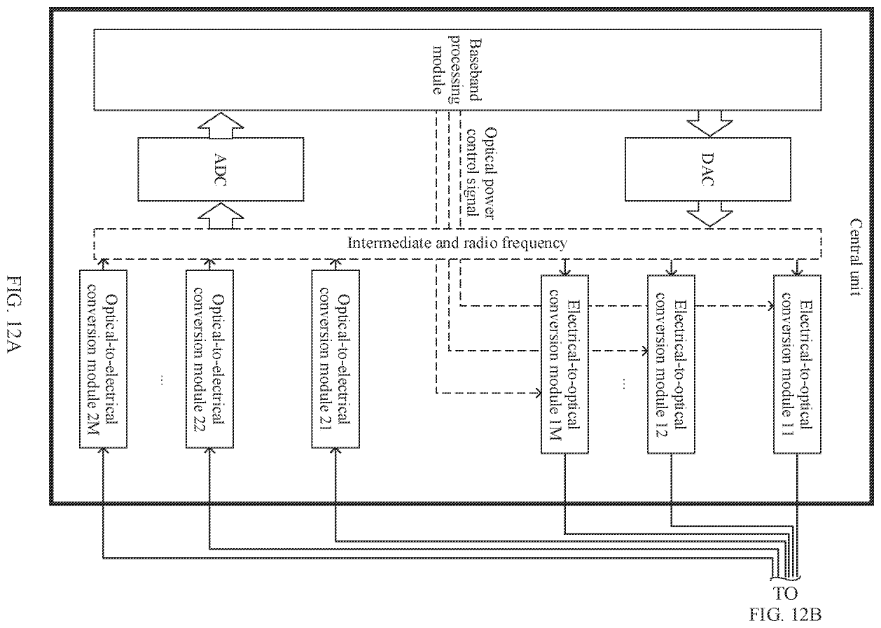

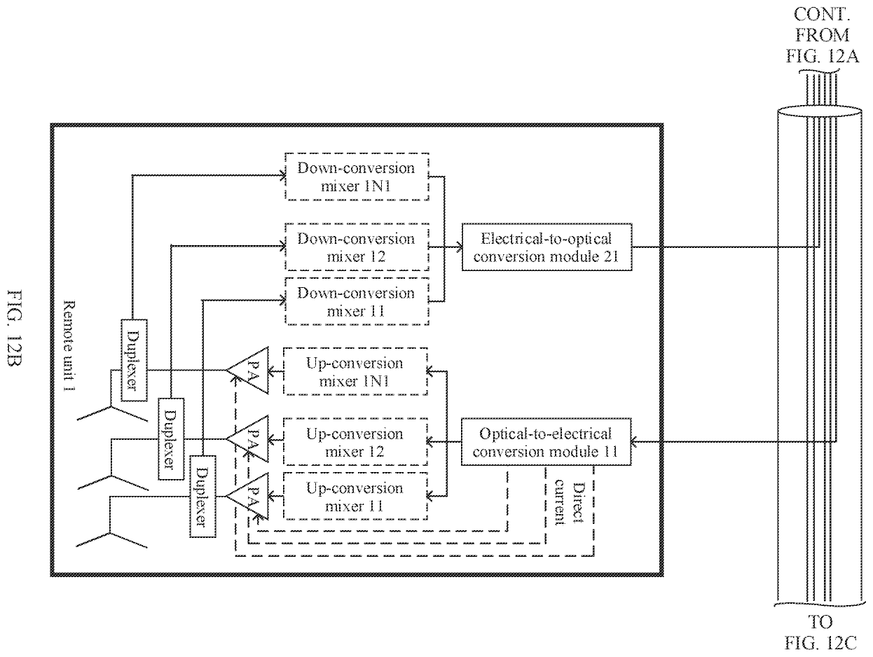

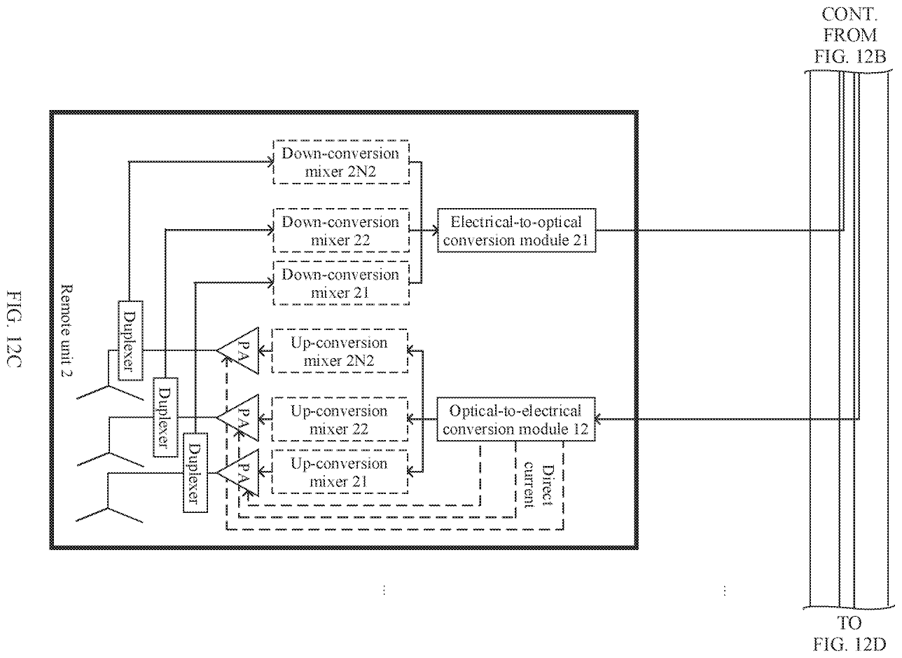

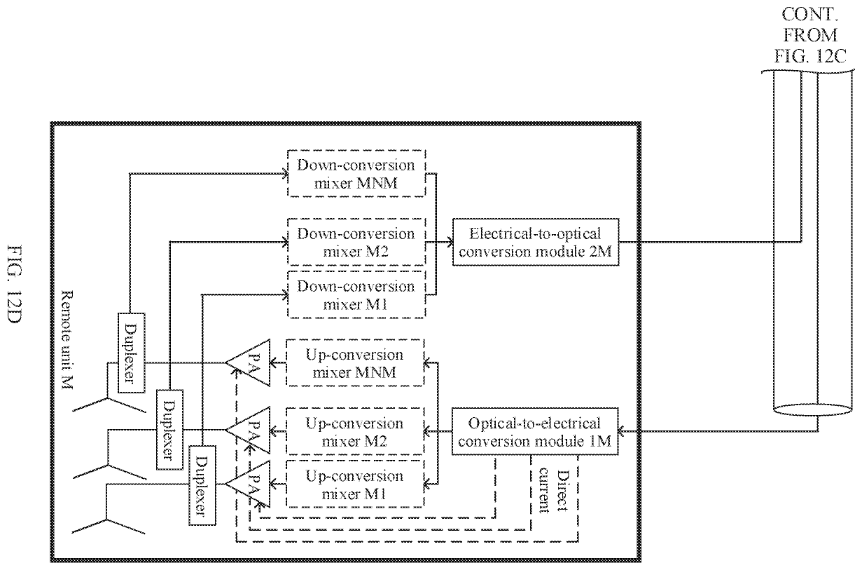

Optionally, FIG. 12A to FIG. 12D are schematic diagrams depicting a structure of another specific small cell system according to an embodiment of this application.

As shown in FIG. 12A to FIG. 12D, the small cell system includes a central unit and M remote units.

A first electrical-to-optical conversion module is configured to convert M first analog electrical signals into M first optical signals, and output the M first optical signals to the remote unit, where M is an integer greater than or equal to 1. A first optical-to-electrical conversion module is configured to convert N second optical signals received from the remote unit into N second analog electrical signals, where N is an integer greater than or equal to 1.

In embodiments of this application, the first electrical-to-optical conversion module may be M independent electrical-to-optical conversion modules, or may be a module in which the M electrical-to-optical conversion modules are integrated, or may be K modules integrated by M electrical-to-optical conversion modules. For example, M is 100, every four of the 100 electrical-to-optical conversion modules are integrated, and K=25. Specific values of M and K may be set based on an actual application scenario. This is not limited in embodiments of this application.

In embodiments of this application, the first optical-to-electrical conversion module may be N independent optical-to-electrical conversion modules, or may be a module in which the N optical-to-electrical conversion modules are integrated, or may be L modules integrated by N optical-to-electrical conversion modules. For example, N is 100, every four of the 100 electrical-to-optical conversion modules are integrated, and L=25. Specific values of N and L may be set based on an actual application scenario. This is not limited in embodiments of this application.

It should be noted that M and N may be the same or different. In FIG. 12A to FIG. 12D, an example in which M and N are the same is used, and values of M and N are not limited.

In embodiments of this application, an electrical-to-optical conversion module of the central unit and the remote unit are connected through an optical fiber. Therefore, there may be electrical-to-optical conversion modules having a same output wavelength in the M electrical-to-optical conversion modules, and a performance requirement on the electrical-to-optical conversion modules is low. Therefore, cost overheads caused by disposing electrical-to-optical conversion modules with different wavelengths can be reduced.

Optionally, the optical fiber may be a multi-core optical fiber, an optical cable, or the like. The multi-core optical fiber refers to a plurality of fiber cores in a same optical fiber. The optical cable refers to a plurality of optical fibers combined into an optical cable. This reduces the complexity of route layout.

There may be optical-to-electrical conversion modules having a same output wavelength in the N optical-to-electrical conversion modules, and a performance requirement on the optical-to-electrical conversion modules is low. Therefore, cost overheads caused by disposing optical-to-electrical conversion modules with different wavelengths can be reduced.

For example, in the small cell system shown in FIG. 12A to FIG. 12D, a signal processing process may be as follows.

In a Transmit Link:

In the central unit, the baseband processing module generates M baseband signals. The M baseband signals are converted into M analog electrical signals through the DAC module. The M analog electrical signals are converted into zero frequency electrical signals, intermediate frequency electrical signals, or radio frequency electrical signals by an optional intermediate and/or radio frequency module. The M zero frequency signals, intermediate frequency signals, or radio frequency electrical signals are converted to optical signals through an electrical-to-optical conversion module 11, an electrical-optical conversion module 12 . . . , and an electrical-optical conversion module 1M. M optical signals are transmitted through an optical fiber transmit link.

In the optical fiber transmit link, M optical fibers are split. In other words, the M optical signals are split. The M optical signals respectively enter a remote unit 1, a remote unit 2 . . . , and a remote unit M.

In each remote unit, the optical-to-electrical conversion module converts an optical signal into an analog electrical signal. The analog electrical signal is converted to a specified frequency through an optional up-conversion mixer module. The analog electrical signal is amplified by a PA The amplified signal is transmitted through a duplexer and an antenna.

Optionally, in the central unit, the baseband processing module sends M optical power control signals, and the M optical power control signals respectively control output optical power of the electrical-to-optical conversion module 11, the electrical-to-optical conversion module 12 . . . , and the electrical-to-optical conversion module 1M. In each remote unit, an optical-to-electrical conversion module controls an amplification multiple of a PA based on a direct current output of an optical power control signal.

In a Receive Link:

In each remote unit, the antenna receives an analog electrical signal. The analog electrical signal is transmitted to the receive link through the duplexer. The analog electrical signal is converted to a specified frequency through an optional down-conversion mixer module. The analog electrical signal is converted into an optical signal through the electrical-to-optical conversion module. The optical signal is transmitted through the optical fiber transmit link.

In the optical fiber transmit link, the M optical signals are transmitted to the central unit through optical fibers.

M optical signals are split in the central unit. An optical-to-electrical conversion module 21, an optical-to-electrical conversion module 22 . . . , and an optical-to-electrical conversion module 2M convert an optical signal into an analog electrical signal. The analog electrical signal is converted to a specified frequency through an optional intermediate and/or radio frequency module. The analog electrical signal is converted into a digital signal through an ADC module. The digital signal is demodulated by the baseband processing module.

In embodiments of this application, a MIMO function may be implemented. For example, in the transmit link, analog electrical signals include signals of 0.4 GHz to 0.6 GHz and 0.8 to 1 GHz. A signal of 0.4 GHz to 0.6 GHz may be converted into 2.4 GHz and transmitted to four antennas, and the signal of 0.8 GHz to 1 GHz signal may be converted into 3.5 GHz and transmitted to two antennas. In this way, the MIMO function is implemented.

It should be noted that the embodiments in FIG. 9A to FIG. 12D may be independently used, or may be cross-multiplexed. This is not limited in this application.

In the embodiments in FIG. 9A to FIG. 12D, there is no one-to-one correspondence between baseband signals and remote units. For example, a plurality of baseband signals may be input into one remote unit, and a quantity of baseband signals is greater than a quantity of remote units. This is not limited in embodiments of this application.

It should be noted that the foregoing embodiments of this application may be applied to a distributed MIMO system of a macro base station or another system. In this way, a central unit is connected to a plurality of remote units, and the plurality of remote units form a distributed MIMO system.

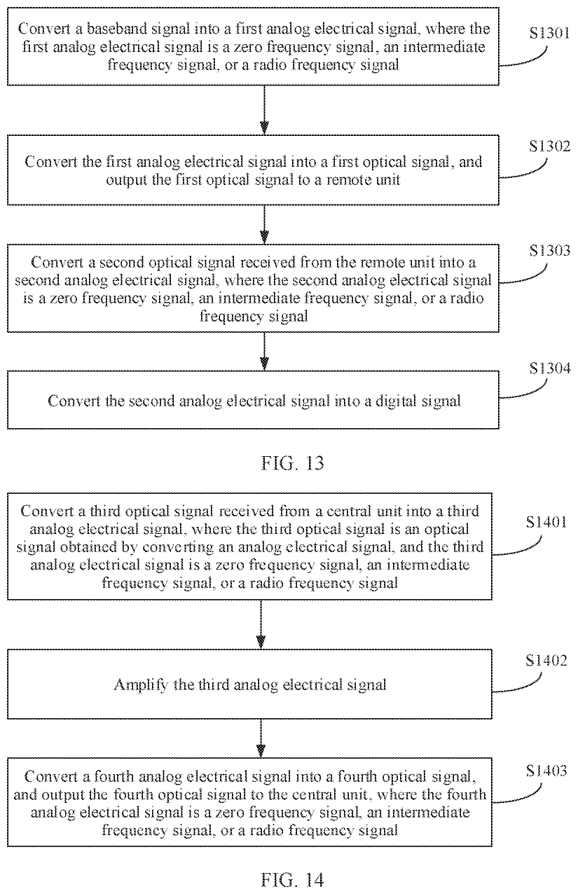

FIG. 13 is a schematic flowchart of a communication method. As shown in FIG. 13, the method is applied to the central unit in any one of the foregoing embodiments. The method includes the following steps.

S1301: Convert a baseband signal into a first analog electrical signal, where the first analog electrical signal is a zero frequency signal, an intermediate frequency signal, or a radio frequency signal

S1302: Convert the first analog electrical signal into a first optical signal, and output the first optical signal to a remote unit.

S1303: Convert a second optical signal received from the remote unit into a second analog electrical signal, where the second analog electrical signal is a zero frequency signal, an intermediate frequency signal, or a radio frequency signal.

S1304: Convert the second analog electrical signal into a digital signal.

In a possible design, the method further includes: converting the first analog electrical signal into an electrical signal at a first frequency, where the converting the first analog electrical signal into a first optical signal and outputting the first optical signal to a remote unit includes: converting the electrical signal at the first frequency into the first optical signal and outputting the first optical signal to the remote unit; and converting the second analog electrical signal into an electrical signal at a second frequency, where the converting the second analog electrical signal into a digital signal includes: converting an analog electrical signal at the second frequency into the digital signal.

In a possible design, the converting the first analog electrical signal into a first optical signal and outputting the first optical signal to a remote unit includes: converting M first analog electrical signals into M first optical signals and outputting the M first optical signals to the remote unit, where M is an integer greater than or equal to 1; and the converting a second optical signal received from the remote unit into a second analog electrical signal includes: converting N second optical signals received from the remote unit into N second analog electrical signals, where N is an integer greater than or equal to 1.

In a possible design, the converting M first analog electrical signals into M first optical signals and outputting the M first optical signals to the remote unit includes: combining the M first optical signals and outputting the first optical signal to the remote unit; and the converting N second optical signals received from the remote unit into N second analog electrical signals includes: splitting the N second optical signals, and converting the split second optical signals into the N second analog electrical signals.

In a possible design, the method further includes: inputting an optical power control signal to a first electrical-to-optical conversion module; and outputting optical power related to the optical power control signal, where the optical power is used to control an amplification multiple of an amplifier in the remote unit.

In a possible design, the first electrical-to-optical conversion module includes a directly modulated laser source, and the optical power control signal is a direct current bias current. The inputting an optical power control signal to a first electrical-to-optical conversion module includes: inputting the direct current bias current to the directly modulated laser source.

In a possible design, the first electrical-to-optical conversion module includes an indirect modulator and a laser source, the optical power control signal is a direct current bias current, and the inputting an optical power control signal to a first electrical-to-optical conversion module includes: inputting the direct current bias current to the laser source; or the optical power control signal is a bias voltage, and the inputting an optical power control signal to a first electrical-to-optical conversion module includes: inputting the bias voltage to the indirect modulator.

In embodiments of this application, an execution body that performs the method on a central unit side may be a central unit, or may be an apparatus in a central unit (It should be noted that the central unit is used as an example for description in embodiments provided in this application). For example, the apparatus in the central unit may be a chip system, a circuit, a module, or the like. This is not limited in this application.

The method in the embodiment may correspondingly be used to perform the steps performed by the central unit in the foregoing apparatus embodiments. Implementation principles and technical effects thereof are similar, and details are not described herein again.

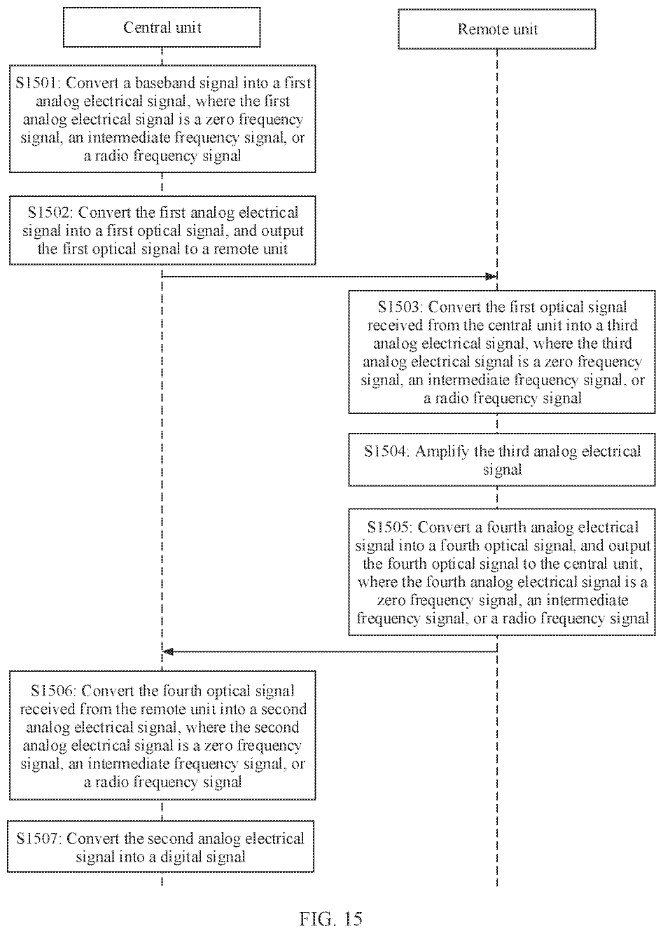

FIG. 14 is a schematic flowchart of a communication method. As shown in FIG. 14, the method is applied to the remote unit in any one of the foregoing embodiments. The method includes the following steps.

S1401: Convert a third optical signal received from a central unit into a third analog electrical signal, where the third optical signal is an optical signal obtained by converting an analog electrical signal, and the third analog electrical signal is a zero frequency signal, an intermediate frequency signal, or a radio frequency signal.

S1402: Amplify the third analog electrical signal.

S1403: Convert a fourth analog electrical signal into a fourth optical signal, and output the fourth optical signal to the central unit, where the fourth analog electrical signal is a zero frequency signal, an intermediate frequency signal, or a radio frequency signal.

In a possible design, the method further includes: converting optical power related to an optical power control signal into a direct current. The amplifying the third analog electrical signal includes: amplifying the third analog electrical signal by using an amplification multiple related to the direct current.

In a possible design, the method further includes: converting the third analog electrical signal into an electrical signal at a third frequency, and the amplifying a third analog electrical signal includes: amplifying the electrical signal at the third frequency; and converting the fourth analog electrical signal into an electrical signal at a fourth frequency, and, the converting a fourth analog electrical signal into a fourth optical signal and outputting the fourth optical signal to a central unit includes: converting the electrical signal at the fourth frequency into the fourth optical signal and outputting the fourth optical signal to the central unit.

In embodiments of this application, an execution body that performs the method on a central unit side may be a remote unit, or may be an apparatus in a remote unit (It should be noted that the remote unit is used as an example for description in embodiments provided in this application). For example, the apparatus in the remote unit may be a chip system, a circuit, a module, or the like. This is not limited in this application.

The method in the embodiments may correspondingly be used to perform the steps performed by the remote unit in the foregoing apparatus embodiments. Implementation principles and technical effects thereof are similar, and details are not described herein again.

FIG. 15 is a schematic flowchart of a communication method. As shown in FIG. 15, the method is applied to the small cell system in any one of the foregoing embodiments. The method includes the following steps.

S1501: A central unit converts a baseband signal into a first analog electrical signal, where the first analog electrical signal is a zero frequency signal, an intermediate frequency signal, or a radio frequency signal.

S1502: The central unit converts the first analog electrical signal into a first optical signal, and outputs the first optical signal to a remote unit.

S1503: The remote unit converts the first optical signal received from the central unit into a third analog electrical signal, where the third analog electrical signal is a zero frequency signal, an intermediate frequency signal, or a radio frequency signal.

S1504: The remote unit amplifies the third analog electrical signal.

S1505: The remote unit converts a fourth analog electrical signal into a fourth optical signal, and outputs the fourth optical signal to the central unit, where the fourth analog electrical signal is a zero frequency signal, an intermediate frequency signal, or a radio frequency signal.

S1506: The central unit converts the fourth optical signal received from the remote unit into a second analog electrical signal, where the second analog electrical signal is a zero frequency signal, an intermediate frequency signal, or a radio frequency signal.

S1507: The central unit converts the second analog electrical signal into a digital signal.

The method in the embodiments may correspondingly be used to perform the steps performed by the small cell system in the foregoing apparatus embodiment. Implementation principles and technical effects thereof are similar, and details are not described herein again. In the several embodiments provided in this application, it should be understood that the disclosed apparatus and method may be implemented in other manners. For example, the described apparatus embodiments are merely an example. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically split, and parts displayed as units may or may not be physical units, may be located in one position, or may be distributed on a plurality of network units. Some or all of the units may be selected based on actual requirements to achieve the objectives of the solutions of the embodiments.

In addition, functional units in embodiments of this application may be integrated into one processing unit, or each of the units may exist alone physically, or two or more units may be integrated into one unit. The integrated unit may be implemented in a form of hardware, or may be implemented in a form of hardware combined with a software function unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, or a network device) or a processor to perform a part of the steps of the methods described in embodiments of this application. The foregoing storage medium includes any medium that can store program code, such as a USB flash drive, a removable hard disk, a read-only memory (ROM), a random access memory (RAM), a magnetic disk, or a compact disc.

1. A central system, wherein the central system comprises:
a digital-to-analog conversion (DAC) circuit an analog-to-digital conversion (ADC) circuit a first electrical-to-optical conversion circuit, and a first optical-to-electrical conversion circuit, wherein;
the DAC circuit is configured to convert a baseband signal into a first analog electrical signal, wherein the first analog electrical signal is a zero frequency signal, an intermediate frequency signal, or a radio frequency signal;
the first electrical-to-optical conversion circuit is configured to convert the first analog electrical signal into a first optical signal, and output the first optical signal to a remote system;
the first optical-to-electrical conversion module circuit is configured to convert a second optical signal received from the remote system into a second analog electrical signal, wherein the second analog electrical signal is a zero frequency signal, an intermediate frequency signal, or a radio frequency signal; and
the ADC circuit is configured to convert the second analog electrical signal into a digital signal.

2. The central system according to claim 1, wherein the central system further comprises an intermediate and/or radio frequency circuit, and wherein:
the intermediate and/or radio frequency circuit is configured to convert the first analog electrical signal into an electrical signal at a first frequency, and the first electrical-to-optical conversion circuit is configured to convert the electrical signal at the first frequency into the first optical signal, and output the first optical signal to the remote system; or
the intermediate and/or radio frequency circuit is configured to convert the second analog electrical signal into, and the ADC circuit is configured to convert an analog electrical signal at A second frequency into the digital signal.

3. The central system, according to claim 1, wherein:
the first electrical-to-optical conversion circuit is configured to convert M first analog electrical signals into M first optical signals, and output the M first optical signals to the remote system, wherein M is an integer greater than or equal to 1; and
the first optical-to-electrical conversion circuit is configured to convert N second optical signals received from the remote system, into N second analog electrical signals, wherein N is an integer greater than or equal to 1.

4. The central system according to claim 3, wherein the central system, further comprises at least one of the following: a first wavelength division multiplexer (MUX) or a first demultiplexer (DEMUX), and wherein:
the first MUX is configured to combine the M first optical signals and output A combined signal to the remote system; and
the first DEMUX is configured to split the N second optical signals and output split second optical signals to the first optical-to-electrical conversion circuit.

5. The central system according to claim 1, wherein:
the central system, is further configured to input an optical power control signal to the first electrical-to-optical conversion circuit and
the first electrical-to-optical conversion circuit is further configured to output optical power related to the optical power control signal, wherein the optical power is used to control an amplification multiple of an amplifier in the remote system.

6. The central system according to claim 5, wherein:
the first electrical-to-optical conversion circuit comprises a directly modulated laser source, and the optical power control signal is a direct current bias current; and
the central system is further configured to input the direct current bias current to the directly modulated laser source.

7. The central system according to claim 5, wherein:
the first electrical-to-optical conversion circuit comprises an indirect modulator and a laser source; and
the optical power control signal is a direct current bias current, and the central system is further configured to input the direct current bias current to the laser source; or
the optical power control signal is a bias voltage, and the central system is further configured to input the bias voltage to the indirect modulator.

8. A remote system, wherein the remote system comprises a second optical-to-electrical conversion circuit, a second electrical-to-optical conversion circuit, and an amplifier, and wherein:
the second optical-to-electrical conversion circuit is configured to convert a third optical signal received from a central system into a third analog electrical signal, wherein the third optical signal is an optical signal obtained by converting an analog electrical signal, and the third analog electrical signal is a zero frequency signal, an intermediate frequency signal, or a radio frequency signal;
the amplifier is configured to amplify the third analog electrical signal; and
the second electrical-to-optical conversion circuit is configured to convert a fourth analog electrical signal into a fourth optical signal, and output the fourth optical signal to the central system, wherein the fourth analog electrical signal is a zero frequency signal, an intermediate frequency signal, or a radio frequency signal.

9. The remote system according to claim 8, wherein:
the second optical-to-electrical conversion circuit is further configured to convert optical power related to an optical power control signal into a direct current; and
the amplifier is further configured to amplify the third analog electrical signal by using an amplification multiple related to the direct current.

10. The remote system according to claim 8, wherein the remote system further comprises an up-conversion mixer circuit and a down-conversion mixer circuit, and wherein:
the up-conversion mixer circuit is configured to convert the third analog electrical signal into an electrical signal at a third frequency, and the amplifier is configured to amplify the electrical signal at the third frequency; and
the down-conversion mixer circuit is configured to convert the fourth analog electrical signal into an electrical signal at a fourth frequency, and the second electrical-to-optical conversion circuit is configured to convert the electrical signal at the fourth frequency into the fourth optical signal, and output the fourth optical signal to the central system.

11. A communication method used in a central system, wherein the communication method comprises:
converting a baseband signal into a first analog electrical signal, wherein the first analog electrical signal is a zero frequency signal, an intermediate frequency signal, or a radio frequency signal;
converting the first analog electrical signal into a first optical signal, and outputting the first optical signal to a remote system;
converting a second optical signal received from the remote system into a second analog electrical signal, wherein the second analog electrical signal is a zero frequency signal, an intermediate frequency signal, or a radio frequency signal; and
converting the second analog electrical signal into a digital signal.

12. The communication method according to claim 11, further comprising:
converting the first analog electrical signal into an electrical signal at a first frequency, wherein the converting the first analog electrical signal into a first optical signal and outputting the first optical signal to a remote system comprises:
converting the electrical signal at the first frequency into the first optical signal and outputting the first optical signal to the remote system; or
converting the second analog electrical signal into an electrical signal at a second frequency, wherein the converting the second analog electrical signal into a digital signal comprises:
converting an analog electrical signal at the second frequency into the digital signal.

13. The communication method according to claim 11, wherein:
the converting the first analog electrical signal into a first optical signal and outputting the first optical signal to a remote system comprises:
converting M first analog electrical signals into M first optical signals and outputting the M first optical signals to the remote system, wherein M is an integer greater than or equal to 1; and
the converting a second optical signal received from the remote system into a second analog electrical signal comprises:
converting N second optical signals received from the remote system into N second analog electrical signals, wherein N is an integer greater than or equal to 1.

14. The communication method according to claim 13, wherein:
the converting M first analog electrical signals into M first optical signals and outputting the M first optical signals to the remote system comprises:
combining the M first optical signals and outputting a combined optical signal to the remote system; and
the converting N second optical signals received from the remote system into N second analog electrical signals comprises:
splitting the N second optical signals, and converting split second optical signals into the N second analog electrical signals.

15. The communication method according to claim 11, further comprising:
inputting an optical power control signal to a first electrical-to-optical conversion circuit; and
outputting optical power related to the optical power control signal, wherein the optical power is used to control an amplification multiple of an amplifier in the remote system.

16. The communication method according to claim 15, wherein:
the first electrical-to-optical conversion circuit comprises a directly modulated laser source, the optical power control signal is a direct current bias current, and
the inputting an optical power control signal to a first electrical-to-optical conversion circuit comprises:
inputting the direct current bias current to the directly modulated laser source.

17. The communication method according to claim 15, wherein the first electrical-to-optical conversion circuit comprises an indirect modulator and a laser source, and wherein:
the optical power control signal is a direct current bias current, and the inputting an optical power control signal to a first electrical-to-optical conversion circuit comprises: inputting the direct current bias current to the laser source; or
the optical power control signal is a bias voltage, and the inputting an optical power control signal to a first electrical-to-optical conversion circuit comprises: inputting the bias voltage to the indirect modulator.
